(19) United States
(12) Patent Application Publication
(10) Pub. No.: US 2026/0074764 A1
(43) Pub. Date: Mar. 12, 2026

(54) METHOD AND APPARATUS FOR REPORTING CHANNEL STATE INFORMATION

(71) Applicant: FUJITSU LIMITED, Kawasaki-shi (JP)

(72) Inventors: Jing ZHU, Beijing (CN); Lei ZHANG, Beijing (CN); Huiting CHENG, Yokohama (JP)

(73) Assignee: FUJITSU LIMITED, Kawasaki-shi (JP)

(21) Appl. No.: 19/387,044

(22) Filed: Nov. 12, 2025

Related U.S. Application Data
(63) Continuation of application No. PCT/CN2023/094276, filed on May 15, 2023.

(51) Int. Cl. H04B 7/06; H04W 24/10

(52) U.S. Cl. CPC H04B 7/0626; H04W 24/10

(57) ABSTRACT

A method and an apparatus for indicating channel state information, the method including: a terminal equipment receives a channel state information (CSI) report configuration, the channel state information (CSI) report configuration being related to L pieces of CSI, the channel state information (CSI) report configuration including S sub-configurations, where 1≤S≤L, one of the S sub-configurations corresponds to at least one piece of channel state information (CSI); the terminal equipment further receives indication information, the indication information being used to trigger (indicate/activate) at least one of the S sub-configurations.

### CROSS-REFERENCE TO RELATED APPLICATION

This application is a continuation application under 35 U.S.C. 111(a) of International Patent Application PCT/CN2023/094276 filed on May 15, 2023, and designated the U.S., the entire contents of which are incorporated herein by reference.

### FIELD

Embodiments of the present disclosure relate to the technical field of communication.

### BACKGROUND

As an important constituent part of global new-type infrastructure construction, fifth-generation (5G) communication networks have achieved rapid development worldwide in recent years. With the popularization of 5G in various industries and its application in more geographical regions, in order to handle more advanced services, very high data rates and denser networks are required, more antennas, greater bandwidths and more frequency bands are used, thereby energy consumption of a 5G device is getting greater and greater.

According to data statistics from operators, average energy consumption of a 5G base station is more than three times that of an LTE base station, and nearly 50% of cost for deploying a 5G network by operators is electricity fee overhead. More importantly, even during periods when there is no service, energy consumption cost of the 5G base station is still very high. Thus, network energy saving has important significance for enhancing sustainability of the environment, reducing impacts (for example reducing greenhouse gas emission) on the environment and saving operating costs, 5G network energy saving is an urgent problem to be solved.

In order to achieve network energy saving, Rel-18 initiated topics related to network energy saving to study various energy-saving technologies. In the discussion, network energy-saving technologies may be classified into types such as time-domain/frequency-domain/spatial-domain/energy-domain energy saving. Spatial-domain energy saving for example is dynamical adjustment of the number of antennas, energy-domain energy saving for example is dynamical adjustment of data transmission power, and time-domain energy saving for example is introduction of a cell DTX/DRX technologies, and so on. Using various energy-saving technologies can save a large amount of energy for a network device.

It should be noted that the above introduction to the technical background is just to facilitate a clear and complete description of the technical solutions of the present disclosure, and is elaborated to facilitate understanding of persons skilled in the art. It cannot be considered that these technical solutions are known by persons skilled in the art just because these solutions are elaborated in the Background of the present disclosure.

### SUMMARY

However, the inventor finds that some scenarios of wireless communication applications (such as an energy-saving mode) might have negative impacts. For example, when a network device dynamically adjusts the number of antennas or transmission power, it may cause a change in a corresponding channel, resulting in inaccurate or untimely reporting of Channel State Information (CSI) from a terminal equipment, ultimately affecting transmission performance.

When the network device adjusts an antenna configuration (such as for the purpose of energy saving), the network device triggers/indicates/activates the terminal equipment to report N pieces of CSI in L pieces of CSI, where N<L. How the network device indicates CSI to enable the terminal equipment to transmit a multi-CSI CSI report is a key problem that needs to be solved currently.

For at least one of the above problems, the embodiments of the present disclosure provide a method and an apparatus for indicating channel state information.

According to one aspect of the embodiments of the present disclosure, a method for indicating channel state information (CSI) is provided, including:
a terminal equipment receives a channel state information (CSI) report configuration, the channel state information (CSI) report configuration being related to L pieces of CSI, the channel state information (CSI) report configuration including S sub-configurations, where 1≤S≤L, one of the S sub-configurations corresponds to at least one piece of channel state information (CSI); and
the terminal equipment receives indication information, the indication information being used to trigger (indicate/activate) at least one of the S sub-configurations.

According to another aspect of the embodiments of the present disclosure, an apparatus for indicating channel state information, the apparatus including:
a first receiving unit, configured to receive a channel state information (CSI) report configuration, the channel state information (CSI) report configuration being related to L pieces of CSI, the channel state information (CSI) report configuration including S sub-configurations, where 1≤S≤L, one of the S sub-configurations corresponds to at least one piece of channel state information (CSI); and
a second receiving unit, configured to receive indication information, the indication information being used to trigger (indicate/activate) at least one of the S sub-configurations.

According to another aspect of the embodiments of the present disclosure, a method for indicating channel state information (CSI) is provided, including:
a network device transmits a channel state information (CSI) report configuration, the channel state information (CSI) report configuration being related to L pieces of CSI, the channel state information (CSI) report configuration including S sub-configurations, where 1≤S≤L, one of the S sub-configurations corresponds to at least one piece of channel state information (CSI); and
the network device transmits indication information, the indication information being used to trigger (indicate/activate) at least one of the S sub-configurations.

According to another aspect of the embodiments of the present disclosure, an apparatus for indicating channel state information, the apparatus including:
a first transmitting unit, configured to transmit a channel state information (CSI) report configuration, the channel state information (CSI) report configuration being related to L pieces of CSI, the channel state information (CSI) report configuration including S sub-configurations, where 1≤S≤L, one of the S sub-configurations corresponds to at least one piece of channel state information (CSI); and
a second transmitting unit, configured to transmit indication information, the indication information being used to trigger (indicate/activate) at least one of the S sub-configurations.

According to a further aspect of the embodiments of the present disclosure, a communication system is provided, including:
a network device, configured to transmit a channel state information (CSI) report configuration and indication information; and
a terminal equipment, configured to receive the channel state information (CSI) report configuration and the indication information;
wherein the channel state information (CSI) report configuration is related to L pieces of CSI, the channel state information (CSI) report configuration including S sub-configurations, where 1≤S≤L, one of the S sub-configurations corresponds to at least one piece of channel state information (CSI); the indication information is used to trigger (indicate/activate) at least one of the S sub-configurations.

One of advantageous effects of the embodiments of the present disclosure includes: even in some scenarios (such as an energy-saving mode) of wireless communication applications, a network device is still able to indicate CSI reporting to a terminal equipment efficiently and accurately, thereby the terminal equipment is able to transmit a CSI report efficiently and accurately, CSI reporting overhead can be saved and uplink resources can be saved.

Referring to the later description and drawings, specific implementations of the present disclosure are disclosed in detail, indicating a mode that the principle of the present disclosure may be adopted. It should be understood that the implementations of the present disclosure are not limited in terms of a scope. Within the scope of the terms of the attached claims, the implementations of the present disclosure include many changes, modifications and equivalents.

Features that are described and/or shown for one implementation may be used in the same way or in a similar way in one or more other implementations, may be combined with or replace features in the other implementations.

It should be emphasized that the term “comprise/include” when being used herein refers to presence of a feature, a whole piece, a step or a component, but does not exclude presence or addition of one or more other features, whole pieces, steps or components.

### BRIEF DESCRIPTION OF THE DRAWINGS

An element and a feature described in a drawing or an implementation of the embodiments of the present disclosure may be combined with an element and a feature shown in one or more other drawings or implementations. In addition, in the drawings, similar labels represent corresponding components in several drawings and may be used to indicate corresponding components used in more than one implementation.

FIG. 1 is a schematic diagram of a communication system in the embodiments of the present disclosure;

FIG. 2 is a schematic diagram of PUCCH SP-CSI reporting activation/deactivation MAC CE in the embodiments of the present disclosure;

FIG. 3 is a schematic diagram of a method for indicating channel state information in the embodiments of the present disclosure;

FIG. 4 is another schematic diagram of a method for indicating channel state information in the embodiments of the present disclosure;

FIG. 5 is another schematic diagram of a method for indicating channel state information in the embodiments of the present disclosure;

FIG. 6 is a schematic diagram of an apparatus for indicating channel state information in the embodiments of the present disclosure;

FIG. 7 is a schematic diagram of an apparatus for indicating channel state information in the embodiments of the present disclosure;

FIG. 8 is a schematic diagram of a network device in the embodiments of the present disclosure;

FIG. 9 is a schematic diagram of a terminal equipment in the embodiments of the present disclosure.

### DETAILED DESCRIPTION

Referring to the drawings, through the following Specification, the aforementioned and other features of the present disclosure will become obvious. The Specification and the drawings specifically disclose particular implementations of the present disclosure, showing partial implementations which may adopt the principle of the present disclosure. It should be understood that the present disclosure is not limited to the described implementations, on the contrary, the present disclosure includes all the modifications, variations and equivalents falling within the scope of the attached claims.

In the embodiments of the present disclosure, the term “first” and “second”, etc. are used to distinguish different elements in terms of appellation, but do not represent a spatial arrangement or time sequence, etc. of these elements, and these elements should not be limited by these terms. The term “and/or” includes any and all combinations of one or more of the associated listed terms. The terms “include”, “comprise” and “have”, etc. refer to the presence of stated features, elements, members or components, but do not preclude the presence or addition of one or more other features, elements, members or components.

In the embodiments of the present disclosure, the singular forms “a/an” and “the”, etc. include plural forms, and should be understood broadly as “a kind of” or “a type of”, but are not defined as the meaning of “one”; in addition, the term “the” should be understood to include both the singular forms and the plural forms, unless the context clearly indicates otherwise. In addition, the term “according to” should be understood as “at least partially according to . . . ”, the term “based on” should be understood as “at least partially based on . . . ”, unless the context clearly indicates otherwise.

In the embodiments of the present disclosure, the term “a communication network” or “a wireless communication network” may refer to a network that meets any of the following communication standards, such as Long Term Evolution (LTE), LTE-Advanced (LTE-A), Wideband Code Division Multiple Access (WCDMA), High-Speed Packet Access (HSPA) and so on.

And, communication between devices in a communication system may be carried out according to a communication protocol at any stage, for example may include but be not limited to the following communication protocols: 1G (generation), 2G, 2.5G, 2.75G, 3G, 4G, 4.5G, and 5G, New Radio (NR), future 6G and so on, and/or other communication protocols that are currently known or will be developed in the future.

In the embodiments of the present disclosure, the term “a network device” refers to, for example, a device that accesses a terminal equipment in a communication system to a communication network and provides services to the terminal equipment. The network device may include but be not limited to the following devices: a Base Station (BS), an Access Point (AP), a Transmission Reception Point (TRP), a broadcast transmitter, a Mobile Management Entity (MME), a gateway, a server, a Radio Network Controller (RNC), a Base Station Controller (BSC) and so on.

The base station may include but be not limited to: a node B (NodeB or NB), an evolution node B (eNodeB or eNB), a 5G base station (gNB) and an IAB donor, etc., and may further includes a Remote Radio Head (RRH), a Remote Radio Unit (RRU), a relay or a low power node (such as femeto, pico, etc.). And the term “base station” may include their some or all functions, each base station may provide communication coverage to a specific geographic region. The term “cell” may refer to a BS and/or its coverage area, which depends on the context in which this term is used.

In the embodiments of the present disclosure, the term “User Equipment (UE)” or “Terminal Equipment (TE) or Terminal Device” refers to, for example, a device that accesses a communication network and receives network services through a network device. The terminal equipment may be fixed or mobile, and may also be referred to as Mobile Station (MS), a terminal, Subscriber Station (SS), Access Terminal (AT) and a station and so on.

The terminal equipment may include but be not limited to the following devices: a Cellular Phone, a Personal Digital Assistant (PDA), a wireless modem, a wireless communication device, a handheld device, a machine-type communication device, a laptop computer, a cordless phone, a smart phone, a smart watch, a digital camera and so on.

For another example, under a scenario such as Internet of Things (IoT), the terminal equipment may also be a machine or apparatus for monitoring or measurement, for example may include but be not limited to: a Machine Type Communication (MTC) terminal, a vehicle-mounted communication terminal, a Device to Device (D2D) terminal, a Machine to Machine (M2M) terminal and so on.

Moreover, the term “a network side” or “a network device side” refers to a side of a network, may be a base station, and may include one or more network devices as described above. The term “a user side” or “a terminal side” or “a terminal equipment side” refers to a side of a user or terminal, may be a UE, and may include one or more terminal equipments as described above. If it is not specifically mentioned herein, “a device” may refer to a network device, or may refer to a terminal equipment.

Scenarios of the embodiments of the present disclosure are described through the following examples, however the present disclosure is not limited thereto.

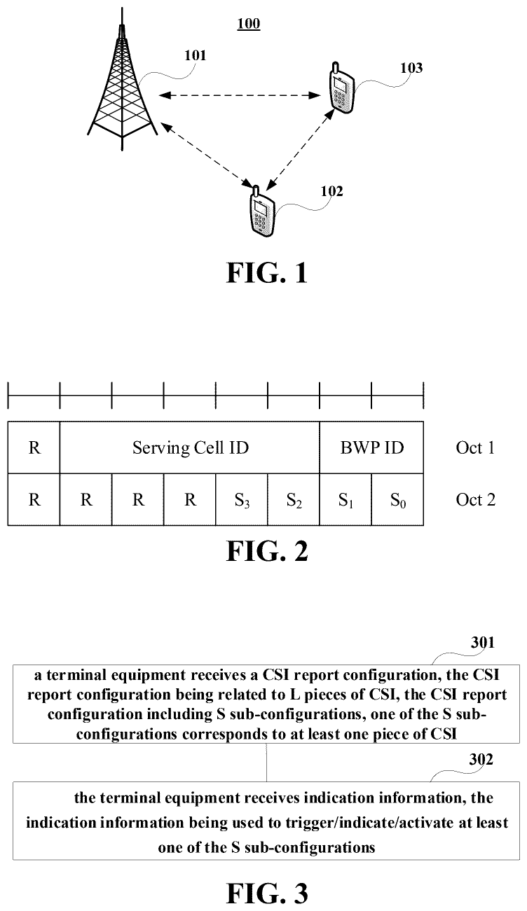

FIG. 1 is a schematic diagram of a communication system in the embodiments of the present disclosure, schematically describes situations by taking a terminal equipment and a network device as examples, as shown in FIG. 1, a communication system 100 may include a network device 101 and terminal equipments 102, 103. For simplicity, FIG. 1 only takes two terminal equipments and one network device as examples for description, however the embodiments of the present disclosure are not limited to this.

In the embodiments of the present disclosure, transmission of existing or further implementable services may be carried out between the network device 101 and the terminal equipments 102, 103. For example, these services may include but be not limited to: enhanced Mobile Broadband (eMBB), massive Machine Type Communication (mMTC), Ultra-Reliable and Low-Latency Communication (URLLC) and so on.

It is worth noting that FIG. 1 shows that two terminal equipments 102 and 103 are within the coverage of network device 101, but the present disclosure is not limited to this. The two terminal equipments 102 and 103 may be outside the coverage of the network device 101, or one terminal equipment 102 may be within the coverage of the network device 101 and the other terminal equipment 103 may be outside the coverage of the network device 101.

In the embodiments of the present disclosure, higher layer signaling may be e.g., radio resource control (RRC) signaling; for example, is called an RRC message, for example includes an MIB, system information, and a dedicated RRC message; or is called an RRC information element (RRC IE). The higher layer signaling, for example, may further be Medium Access Control (MAC) signaling; or called a MAC control element (MAC CE). However, the present disclosure is not limited thereto.

In a mobile communication system, generally a terminal equipment performs Channel State Information (CSI) measurement according to indication and configuration of a network device, and then reports CSI obtained by measurement to the network device. When the network device schedules the terminal equipment, it may refer to this CSI so as to adopt an appropriate transmission mode on an appropriate resource to schedule the terminal equipment to perform transmission. Different terminal equipments may experience different physical channel conditions. Adopting a CSI feedback mechanism may rationally and effectively utilize resources, thereby improving the efficiency of entire network transmission.

In the CSI feedback mechanism of NR, the terminal equipment measures a reference signal based on a CSI configuration and performs reporting. The CSI may include a Channel Quality Indicator (CQI), a Precoding Matrix Indicator (PMI), a CSI-RS Resource Indicator (CRI), a synchronization signal/physical broadcast channel (SS/PBCH) Resource Indicator (SSBRI), a Layer Indicator (LI), and a Rank Indication (RI).

In a CSI report framework of the NR, it is carried out by associating a CSI resource with a CSI report. The CSI report may be configured as the following three types: a periodic CSI report (P-CSI): transmitted only on a Physical Uplink Control Channel (PUCCH); a semi-persistent CSI report (SP-CSI): transmitted on a PUCCH or a Physical Uplink Shared Channel (PUSCH); an aperiodic CSI report (AP-CSI): transmitted only on a PUSCH.

The following text first describes the PUSCH-based semi-persistent CSI (or semi-persistent CSI carried by a PUSCH, hereinafter referred to as PUSCH semi-persistent CSI).

Under a CSI feedback framework, a network device configures a set of trigger states for a terminal equipment via an RRC higher-layer parameter CSI-SemiPersistentOnPUSCH-TriggerStateList, and each trigger state corresponds to one CSI reporting setting. The network device activates or deactivates a trigger state via a CSI request field in DCI, and there may be multiple PUSCH-based SP-CSIs in an activated state at the same moment. One terminal equipment (UE) does not expect to receive a DCI scrambled with an SP-CSI-RNTI, the DCI activates a semi-persistent CSI report that has already been activated by a previous DCI and has the same CSI-reportconfigid.

According to a position sequence of the trigger states configured in CSI-SemiPersistentOnPUSCH-TriggerStateList, codepoints of the CSI request field in the DCI are mapped to an SP-CSI trigger state, and codepoint “0” is mapped to a trigger state at the first position. For activation or deactivation of the semi-persistent CSI, the terminal equipment verifies a PDCCH of the DCI only when the following conditions are met:
scrambling with an SP-CSI-RNTI provided by a higher-layer parameter sp-CSI-RNTI for a CRC parity check bit in a DCI format;
settings of a DCI format special field are shown in the following Table 1 or Table 2:

TABLE 1
a special field for PDCCH validation
of semi-persistent CSI activation

| | DCI format 0_1/0_2 |
|---|---|
| HARQ process number | set to all ‘0’s |
| (if present) | |
| Redundancy version | set to all ‘0’s |
| (if present) | |

TABLE 2
a special field for PDCCH validation
of semi-persistent CSI deactivation

| | DCI format 0_1/0_2 |
|---|---|
| HARQ process number | set to all ‘0’s |
| (if present) | |
| Modulation and coding | set to all ‘1’s |
| scheme | |
| Resource block | If higher layer configures RA type 0 only, |
| assignment | set to all ‘0’s; |
| | If higher layer configures RA type 1 only, |
| | set to all ‘1’s; |
| | If higher layer configures dynamic switch |
| | between RA type 0 and 1, then if MSB is‘0’, |
| | set to all ‘0’s; else, set to all ‘1’s |
| | For DCI 0_1, if higher layer configures RA |
| | type 2, set to all ‘1’s if μ = 0; |
| | set to all ‘0’s if μ = 1 |
| Redundancy version | set to all ‘0’s |
| (if present) | |

If verification is achieved, the terminal equipment regards information in a DCI format as valid activation or valid deactivation of PUSCH-based semi-persistent CSI transmission, and the terminal equipment activates or deactivates CSI reporting settings indicated by a CSI request field in the DCI. If the verification is not successful, the terminal equipment considers that the DCI format has detected an unmatched CRC.

For example, the terminal equipment receives a trigger state list CSI-SemiPersistentOnPUSCH-TriggerStateList configured by RRC. The terminal equipment receives DCI format 0_1/0_2, if the DCI format is scrambled with an SP-CSI-RNTI and special fields in DCI Format 0_1 correspond to activation of a semi-persistent CSI, the terminal equipment obtains a CSI report config ID according to a CSI trigger state corresponding to a codepoint in the CSI request field; the terminal equipment determines a CSI report that needs to be activated.

For another example, the terminal equipment receives DCI format 0_1/0_2, if the DCI format is scrambled with an SP-CSI-RNTI and special fields in DCI Format 0_1 correspond to deactivation of a semi-persistent CSI, the terminal equipment obtains a CSI report config ID according to a CSI trigger state corresponding to a codepoint in the CSI request field; the terminal equipment determines a CSI report that needs to be deactivated.

CSI-SemiPersistentOnPUSCH-TriggerStateList IE is used to configure the trigger state list for semi-persistent CSI reporting to the terminal equipment. For example, it may be shown in the following Table 3.

TABLE 3
CSI-SemiPersistentOnPUSCH-TriggerStateList IE

-- ASN1START
-- TAG-CSI-SEMIPERSISTENTONPUSCHTRIGGERSTATELIST-START

| | |
|---|---|
| CSI-SemiPersistentOnPUSCH-TriggerStateList | ::= SEQUENCE(SIZE |

(1..maxNrOfSemiPersistentPUSCH-Triggers)) OF CSI-SemiPersistentOnPUSCH-TriggerState

| | |
|---|---|
| CSI-SemiPersistentOnPUSCH-TriggerState ::= | SEQUENCE { |
| associatedReportConfigInfo | CSI-ReportConfigId, |

```
  ...,
  [[
```

| | |
|---|---|
| sp-CSI-MultiplexingMode-r17 | ENUMERATED {enabled} |

OPTIONAL -- Need R
]]
}
-- TAG-CSI-SEMIPERSISTENTONPUSCHTRIGGERSTATELIST-STOP
-- ASN1STOP

The following text then describes the PUSCH-based aperiodic CSI (or aperiodic CSI carried by a PUSCH, hereinafter referred to as PUSCH aperiodic CSI).

Under a CSI feedback framework, a network device configures a set of trigger states for a terminal equipment via an RRC higher-layer parameter CSI-AperiodicTriggerStateList, and each trigger state may correspond to multiple CSI reporting settings. The network device activates one trigger state via a CSI request field in the DCI.

CSI-AperiodicTriggerStateList IE is used to configure an aperiodic trigger state list for the terminal equipment. Each codepoint of the DCI field “CSI request” is associated with one trigger state. When receiving a value associated with a trigger state, the terminal equipment will perform CSI-RS, CSI-IM and/or SSB (reference signal) measurements, and perform non-periodical reporting on L1 according to all entries in associatedReportConfigInfoList of the trigger state.

TABLE 4
CSI-AperiodicTriggerStateList IE

-- ASN1START
-- TAG-CSI-APERIODICTRIGGERSTATELIST-START

| | |
|---|---|
| CSI-AperiodicTriggerStateList ::= | SEQUENCE (SIZE (1..maxNrOfCSI-AperiodicTriggers)) OF CSI- |

AperiodicTriggerState

| | |
|---|---|
| CSI-AperiodicTriggerState ::= | SEQUENCE { |
| associatedReportConfigInfoList | SEQUENCE |

```
(SIZE(1..maxNrofReportConfigPerAperiodicTrigger)) OF CSI-AssociatedReportConfigInfo,
  ...,
  [[
```

| | |
|---|---|
| ap-CSI-MultiplexingMode-r17 | ENUMERATED {enabled} |

OPTIONAL -- Need R
]]

The following text then describes the PUCCH-based semi-persistent CSI (or semi-persistent CSI carried by a PUCCH, hereinafter referred to as PUCCH semi-persistent CSI).

For the PUCCH semi-persistent CSI, a PUCCH resource for transmitting a CSI report is configured by reportConfigType. The PUCCH semi-persistent CSI is activated by an activation command, the command selects one semi-persistent reporting setting of a PUCCH for use by the terminal equipment. When the terminal equipment transmits a PUCCH carrying HARQ-ACK information on slot n corresponding to a PDSCH carrying the activation command, specified semi-persistent reporting settings should be applied starting from the first slot after slot n+

$$3 {N}_{slot}^{subframe , μ} ,$$

where μ is an SCS configuration of the PUCCH.

FIG. 2 is a schematic diagram of PUCCH SP-CSI reporting activation/deactivation MAC CE in the embodiments of the present disclosure, identified by a MAC subheader with an LCID. As shown in FIG. 2, this MAC CE includes a fixed 16-bit size and contains the following fields:
a serving cell ID: this field indicates an identifier of a serving cell in which the MAC CE is applied; a field length is 5 bits;
a BWP ID: this field indicates an UL BWP in which the MAC CE is applied, and serves as a codepoint of a DCI bandwidth part indication field. A length of the BWP ID field is 2 bits;
Sᵢ: indicating an activation/deactivation state of a semi-persistent CSI report configuration in CSI-reportconfigtoaddmodlist. S₀ indicates a report configuration, including a PUCCH resource for SP CSI reporting in a specified BWP, and having the lowest CSI-reportconfigid in a list whose type is set to be semiPersistentOnPUCCH; S₁ indicates a report configuration, including a PUCCH resource for SP CSI reporting in a specified BWP, and having the second-lowest CSI-reportconfigid, the rest may be done in the same manner. If the number of report configurations in the list whose type is set to be semiPersistentOnPUCCH in the specified BWP is less than i+1, an MAC entity will ignore the Sᵢ field. Setting the Sᵢ field to 1 indicates that a corresponding semi-persistent CSI report configuration will be activated. Setting the Sᵢ field to 0 indicates that a corresponding semi-persistent CSI report configuration will be deactivated.
R: a reserved bit, which is set to 0.

The above text illustratively describes the PUSCH-based semi-persistent CSI, the PUCCH-based aperiodic CSI and the PUCCH-based semi-persistent CSI, the embodiments of the present disclosure are not limited thereto.

The inventor finds that in order to achieve network energy saving, a network device needs to adjust an antenna configuration for serving a terminal equipment according to real-time demands of a network service, such as the number of antenna elements, antenna ports, etc. To ensure that the network device obtains CSI timely and accurately, a feasible solution is that a terminal equipment simultaneously reports multiple CSIs corresponding to different antenna configuration schemes at a reporting moment. However, how the network device indicates CSI to the terminal equipment to enable the terminal equipment to perform multi-CSI CSI reporting has become an urgent problem to be solved. The following text takes an energy-saving scenario as an example for description, but the present disclosure is not limited thereto, and may be applied to any scenario involving a channel state information report.

### Embodiments of a First Aspect

Embodiments of the present disclosure provide a method for indicating channel state information, which is described from a terminal equipment side. FIG. 3 is a schematic diagram of a method for indicating channel state information in the embodiments of the present disclosure, as shown in FIG. 3, the method includes:
301, a terminal equipment receives a channel state information (CSI) report configuration, the channel state information (CSI) report configuration being related to L pieces of CSI, the channel state information (CSI) report configuration including S sub-configurations, where 1≤S≤L, one of the S sub-configurations corresponds to at least one piece of channel state information (CSI); and
302, the terminal equipment receives indication information, the indication information being used to trigger/indicate/activate at least one of the S sub-configurations.

It should be noted that the above FIG. 3 only schematically describes the embodiments of the present disclosure, but the present disclosure is not limited thereto. For example, an execution step of each operation may be adjusted appropriately, moreover other some operations may be added or one or more operations may be removed. Persons skilled in the art may make appropriate modifications according to the above contents, not limited to the records in the above FIG. 3.

In some embodiments, the number of PUSCH-based semi-persistent CSI report configurations that include at least one sub-configuration is H, and/or, the number of PUSCH-based aperiodic CSI report configurations that include at least one sub-configuration is Q, and/or, the number of PUCCH-based semi-persistent CSI report configurations that include at least one sub-configuration is R, where H, Q and R are positive integers.

For example, the number H of PUSCH-based semi-persistent CSI report configurations that include at least one sub-configuration is 1, and/or, the number Q of PUSCH-based aperiodic CSI report configurations that include at least one sub-configuration is 1, and/or, the number R of PUCCH-based semi-persistent CSI report configurations that include at least one sub-configuration is 1.

In some embodiments, one CSI report configuration includes P CSI sub-configurations, one of the CSI sub-configurations corresponds to one piece of CSI, for example, corresponds to one spatial domain/energy domain adjustment mode. The terminal equipment may report N pieces of CSI at one CSI report moment, and the N pieces of CSI are associated with N CSI sub-configurations in P sub-configurations.

The terminal equipment reports a CSI report at a CSI report time, the CSI report including a first CSI, a second CSI . . . a Nth CSI which correspond to sub-configuration 1, sub-configuration 2 . . . sub-configuration N of the CSI respectively, different sub-configurations correspond to different spatial domain/energy domain adjustment modes.

By taking N=4 as an example, the CSI report includes four CSIs, the first CSI (CSI of sub-configuration 1) corresponds to a spatial domain adjustment mode of CSI-RS 32-port, the second CSI (CSI of sub-configuration 2) corresponds to a spatial domain adjustment mode of 16-port, the third CSI (CSI of sub-configuration 3) corresponds to a spatial domain adjustment mode of 8-port, and the fourth CSI (CSI of sub-configuration 4) corresponds to a spatial domain adjustment mode of 4-port.

In some embodiments, the first CSI is a baseline CSI. By taking “a CSI-RS resource set includes a plurality of resources, each resource being associated with at least one spatial domain adjustment mode” as an example, each resource is associated with four spatial domain adjustment modes, and the four spatial domain adjustment modes correspond to 32-port, 16-port, 8-port and 4-port respectively, the 16-port, 8-port and 4-port are subsets of the 32-port, that is, resources associated with the second CSI, the third CSI and the fourth CSI are subsets of resources associated with the first CSI, partial information of the second CSI, the third CSI and the fourth CSI may be obtained from the first CSI, thus the first CSI is a baseline CSI.

In the embodiments of the present disclosure, for ease of description, CSI of sub-configuration 1, sub-configuration 2 . . . sub-configuration N may replace the first CSI, the second CSI . . . the Nth CSI. The sub-configuration may be replaced by a group, a configuration, a mode, a pattern, a sub-group, a sub-mode, or a sub-pattern, etc.

In some embodiments, the sub-configuration includes at least one of the following information: parameter N1; parameter N2; parameter Ng; a codebook subset restriction; port information, the port information being used to indicate partial ports of channel state information reference signal (CSI-RS) resources associated with the channel state information (CSI) report configuration.

For example, the port information indicates partial ports or port subsets in the form of a bitmap, wherein each bit in the bitmap represents a port, a code division multiplexing (CDM) group, or a predefined port group.

In some embodiments, the maximum number of sub-configurations included in the CSI report configuration may be configured via an RRC parameter, such as maxNrOfSubConfig, the parameter being included in Multiplicity and type constraint definitions or in CSI-ReportConfig.

In some embodiments, the sub-configuration is included in sub-configuration information (such as sub-config) of the channel state information (CSI) report configuration, or is included in codebook configuration information (such as codebook config) of the channel state information (CSI) report configuration, or is included in parameter configuration information (such as N1-N2 config) of the channel state information (CSI) report configuration.

For example, the CSI report configuration includes a sub-config list, one sub-config in the list including codebook configuration information (codebook config or codebook Type or a codebook subset restriction, N1, N2 and Ng) and/or port information; or the CSI report configuration includes P sub-configurations, i.e., sub-config1 to sub-config P, each sub-config including codebook configuration information (codebook config or codebook Type or a codebook subset restriction) and/or port information.

For another example, the codebook configuration (codebook config) in the CSI report configuration includes codebook configuration 1 to codebook configuration P, corresponding to P sub-configurations respectively, one of codebook configuration 1 to codebook configuration P including information such as a codebook subset restriction, N1, N2 and Ng; port information indicated by a port subset does not need to be obtained via explicit indication information, and may be obtained via other predefined modes or implicit modes.

For another example, the codebook configuration (codebook config) in the CSI report configuration includes N1-N2 1 to N1-N2 P, corresponding to P sub-configurations respectively, one of codebook configuration 1 to codebook configuration P including information such as N1, N2 and Ng; port information indicated by a port subset does not need to be obtained via explicit indication information, and may be obtained via other predefined modes or implicit modes; in the CSI report configuration, only one common codebook subset restriction parameter is configured, codebook subset restriction information of each sub-configuration is obtained from the common codebook subset restriction parameter based on parameters N1, N2 and Ng.

The CSI report configuration includes P sub-configurations, which may be that a CSI reporting configuration includes P-1 sub-configurations/codebook configuration indices/identifiers/information, or the sub-configuration list includes P-1 sub-configurations, or the codebook configuration list includes P-1 codebook configurations, the P-1 sub-configurations/codebook configuration indices/identifiers/information or P-1 sub-configurations or P-1 codebook configurations respectively correspond to P-1 sub-configurations, a resource configuration and a codebook configuration included in the CSI report configuration are one sub-configuration. Therefore, the CSI report configuration includes P sub-configurations.

Or, the CSI report configuration includes P sub-configurations, which may be that a CSI reporting configuration includes P sub-configurations/codebook configuration indices/identifiers/information, or the sub-configuration list includes P sub-configurations, or the codebook configuration list includes P codebook configurations, one of the P sub-configurations/codebook configuration indices/identifiers/information or P sub-configurations or P codebook configurations is a resource configuration and a codebook configuration included in the CSI report configuration. Therefore, the CSI report configuration includes P sub-configurations.

In the embodiments of the present disclosure, terms “index”, “identifier” and “information” are interchangeable, the present disclosure is not limited thereto.

In some embodiments, the channel state information (CSI) report configuration may be configured via radio resource control (RRC) signaling, and the indication information may be DCI or an MAC CE. The indication information is used to indicate the terminal equipment to report a CSI report at a CSI reporting time, the CSI report including N pieces of CSI, i.e., a first CSI, a second CSI . . . a Nth CSI, that is, CSI of sub-configuration 1, CSI of sub-configuration 2 . . . . CSI of sub-configuration N.

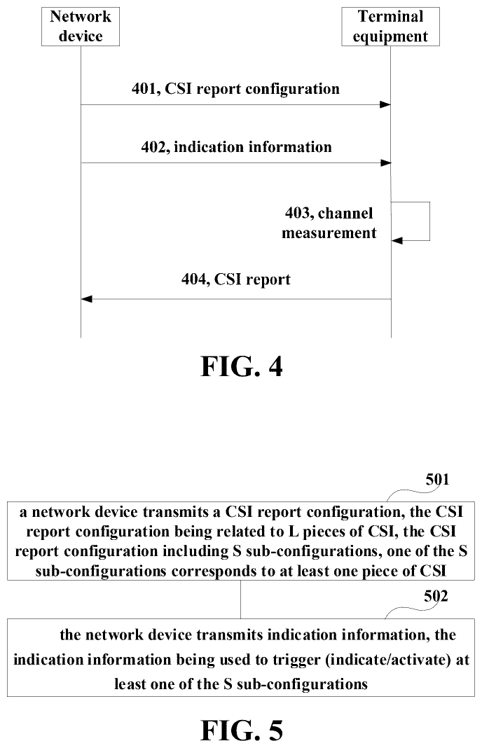

FIG. 4 is another schematic diagram of a method for indicating channel state information in the embodiments of the present disclosure. As shown in FIG. 4, the method includes:
401, a terminal equipment receives a channel state information (CSI) report configuration, the channel state information (CSI) report configuration being related to L pieces of CSI, the channel state information (CSI) report configuration including S sub-configurations, where 1≤S≤L, one of the S sub-configurations corresponds to at least one piece of channel state information (CSI); and
402, the terminal equipment receives indication information, the indication information being used to trigger (indicate/activate) at least one of the S sub-configurations.

As shown in FIG. 4, the method may further include:
403, the terminal equipment performs channel measurement according to triggered/indicated/activated M sub-configurations in S sub-configurations; and
404, the terminal equipment transmits a channel state information (CSI) report, the channel state information (CSI) report including N pieces of channel state information (CSI); wherein the M sub-configurations correspond to N pieces of channel state information, 1≤M≤N.

It should be noted that the above FIG. 4 only schematically describes the embodiments of the present disclosure, but the present disclosure is not limited thereto. For example, an execution step of each operation may be adjusted appropriately, moreover other some operations may be added or one or more operations may be removed. Persons skilled in the art may make appropriate modifications according to the above contents, not limited to the records in the above FIG. 4.

In some embodiments, the channel state information (CSI) report configuration is for physical uplink shared channel (PUSCH) semi-persistent CSI reporting. A first trigger/indication/activation state list may be configured via RRC, and the first trigger/indication/activation state list includes a set of X1 trigger (indication/activation) states.

In some embodiments, the first trigger/indication/activation state list for PUSCH semi-persistent CSI reporting is S sub-configurations in the CSI report configuration, one trigger/indication/activation state in the list is one sub-configuration. Or, one trigger (indication/activation) state in the list is associated with one CSI report configuration, i.e., one trigger (indication/activation) state in the list associates with/includes one piece of associated report configuration information, the associated report configuration information may be associated with at least one sub-configuration, i.e., one associated sub-configuration list is included under the associated report configuration information.

For example, sub-config1 to sub-config S or codebook config 1 to codebook config S in the CSI report configuration are S sub-configurations, each trigger/indication/activation is one sub-configuration. If one sub-configuration corresponds to one CSI, X=S=L; and if one sub-configuration corresponds to multiple CSIs, X=S<L. Thereby, RRC signaling overhead may be saved, and there is no need to separately configure the trigger/indication/activation (state) list. In some embodiments, the first trigger/indication/activation state list for PUSCH semi-persistent CSI reporting is an existing IE or a newly defined IE, one trigger (indication/activation) state in the list is associated with at least one CSI report configuration index and/or at least one sub-configuration. Or, one trigger (indication/activation) state in the list is associated with one CSI report configuration, i.e., one trigger (indication/activation) state in the list associates with/includes one piece of associated report configuration information, the associated report configuration information may be associated with at least one sub-configuration, i.e., one associated sub-configuration list is included under the associated report configuration information.

For example, the first trigger/indication/activation state list for PUSCH semi-persistent CSI reporting may reuse the existing IE (such as CSI-SemiPersistentOnPUSCH-TriggerStateList), and in each trigger state in the list, a new parameter is added, the parameter is used to associate sub-configurations or CSI-RS resources, and the parameter for example is associatedsubConfigInfo or associatedResourceConfigInfo. The parameter type or value may be a sub-configuration index or a CSI-ResourcConfig index, the sub-configuration index is an index of one sub-configuration among the S sub-configurations in the CSI report configuration, and the sub-configuration index may be a positive integer.

The newly added parameter (associatedSubConfigInfo or associatedResourceConfigInfo) is an optional parameter, for example when the trigger state is only used for CSI report activation/deactivation, the newly added parameter (associatedSubConfigInfo or associatedResourceConfigInfo) is not configured; and/or, when the trigger state is used for CSI report activation/deactivation and triggering/indication/activation of a sub-configuration, the newly added parameter (associatedSubConfigInfo or associatedResourceConfigInfo) is configured, the trigger state is associated with CSI-ReportConfigId, meanwhile is also associated with a sub-configuration or CSI-ResourceConfig. Thus, the first trigger/indication/activation state list for PUSCH semi-persistent CSI reporting is used both for activation/deactivation of a CSI report and for triggering/indication/activation of a sub-configuration.

Table 5 shows an example of a trigger/indication/activation state list for PUSCH semi-persistent CSI reporting.

TABLE 5
CSI-SemiPersistentOnPUSCH-TriggerStateList ::= SEQUENCE(SIZE
(1..maxNrOfSemiPersistentPUSCH-Triggers)) OF CSI-SemiPersistentOnPUSCH-TriggerState

| | |
|---|---|
| CSI-SemiPersistentOnPUSCH-TriggerState ::= | SEQUENCE { |
| associatedReportConfigInfo | CSI-ReportConfigId, |

associatedSubConfigInfoList : : = SEQUENCE(SIZE (1..maxNrOfSub-config)) OF

| | |
|---|---|
| associatedSubConfigInfo | OPTIONAL -- Need R |

```
  ...,
  [[
```

| | |
|---|---|
| sp-CSI-MultiplexingMode-r17 | ENUMERATED {enabled} OPTIONAL -- Need R |

]]
}

| | |
|---|---|
| AssociatedSubConfigInfo ::= | SEQUENCE { |
| AssociatedSubConfigInfo | sub-configId } |

Table 6 shows another example of a trigger/indication/activation state list for PUSCH semi-persistent CSI reporting.

TABLE 6
CSI-SemiPersistentOnPUSCH-TriggerStateList ::= SEQUENCE(SIZE (1..maxNrOfSemiPersistentPUSCH-
Triggers)) OF CSI-SemiPersistentOnPUSCH-TriggerState

| | |
|---|---|
| CSI-SemiPersistentOnPUSCH-TriggerState ::= | SEQUENCE { |
| associatedReportConfigInfo | CSI-ReportConfigId, |

associatedResourceConfigInfoList: : = SEQUENCE(SIZE (1..maxNrOfSub-config)) OF

| | |
|---|---|
| associatedResourceConfigInfo | OPTIONAL -- Need R |

[[

| | |
|---|---|
| sp-CSI-MultiplexingMode-r17 | ENUMERATED {enabled} OPTIONAL -- Need R |

]]
}

| | |
|---|---|
| AssociatedResourceConfigInfo ::= | SEQUENCE { |
| AssociatedResourceConfigInfo | CSI-ResourceConfigId } |

For another example, the first trigger/indication/activation state list for PUSCH semi-persistent CSI reporting may further be a newly defined list, for example may be named as CSI-SemiPersistentOnPUSCH-TriggerStateList-r18, or CSI-SemiPersistentOnPUSCH-subConfig-TriggerStateList, or NES-sub-CSI-SemiPersistentOnPUSCH-TriggerStateList. One trigger/indication/activation state in the list may be associated with one CSI report configuration and/or at least one CSI-RS resource configuration index and/or at least one sub-configuration, the first trigger/indication/activation state list may be used both for activation/deactivation of a CSI report and for triggering/indication/activation of a sub-configuration.

Table 7 shows another example of a trigger/indication/activation state list for PUSCH semi-persistent CSI reporting.

TABLE 7

| | |
|---|---|
| CSI-MeasConfig ::= | SEQUENCE { |
| aperiodicTriggerStateList | SetupRelease { CSI-AperiodicTriggerStateList } OPTIONAL, |

-- Need M

| semiPersistentOnPUSCH-TriggerStateList | SetupRelease { CSI-SemiPersistentOnPUSCH- | |
|---|---|---|
| TriggerStateList } | OPTIONAL, -- Need M | |
| semiPersistentOnPUSCH-TriggerStateList | SetupRelease { CSI-SemiPersistentOnPUSCH- | |
| TriggerStateList-r18 } | OPTIONAL, -- Need M | |
| CSI-SemiPersistentOnPUSCH-TriggerStateList-r18 ::= | | SEQUENCE { |
| associatedReportConfigInfo | CSI-ReportConfigId, | |
| associatedSubConfigInfo | sub-configId | OPTIONAL -- Need R |

}

In the above examples of reusing an IE and newly defining an IE, part of the trigger/indication/activation states in the first trigger state list for PUSCH semi-persistent CSI reporting is associated with the CSI report configuration indices, and is used for activation/deactivation of the CSI report. The other part of trigger/indication/activation states in the list is associated with the CSI report configuration indices and/or the sub-configurations, may be simultaneously used for activation of a CSI report configuration associated with trigger/indication/activation states, and triggering/indication/activation of sub-configurations in an activated CSI report configuration, or may be only used for triggering/indication/activation of sub-configurations. Thereby, CSI activation/deactivation, and triggering/indication/activation of sub-configurations share the first trigger/indication/activation state list, saving RRC overhead.

For another example, the first trigger/indication/activation state list for PUSCH semi-persistent CSI reporting is a newly defined IE, one trigger/indication/activation state in the list is associated with one CSI report configuration index and at least one sub-configuration, and is used for triggering/indication/activation of the sub-configuration in the CSI report configuration. Thereby, CSI-SemiPersistentOnPUSCH-TriggerStateList is used for activation/deactivation of the CSI report, and the first trigger/indication/activation state list is used for triggering/indication/activation of the sub-configuration.

For another example, the first trigger/indication/activation state list for PUSCH semi-persistent CSI reporting is a newly defined IE, one trigger/indication/activation state in the list is associated with at least one sub-configuration, and is used for triggering/indication/activation of the at least one sub-configuration. In this method, there is no need to indicate a CSI report configuration index, the number of the CSI report configurations is only one. The network device and the terminal equipment are aware of a CSI report index by default, or the CSI report configuration index has already been indicated via other RRC lists and DCI fields. Therefore, there is no need to indicate the CSI report configuration index here. Thereby, CSI-SemiPersistentOnPUSCH-TriggerStateList is used for activation/deactivation of the CSI report, and the first trigger/indication/activation state list is used for triggering/indication/activation of the sub-configuration.

In the above embodiments, one trigger/indication/activation state in the first trigger/indication/activation state list may be associated with one CSI report configuration index and/or at least one sub-configuration. The sub-configuration may be a sub-configuration (index), a codebook configuration (index), port subset indication information (index), an n1-n2 configuration (index), a CSI-RS resource index, etc. in the CSI report configuration. Each sub-configuration-related parameter is associated with one spatial domain/energy domain adjustment element mode.

For example, one trigger/indication/activation state in the first trigger/indication/activation state list is associated with one CSI report configuration index and at least one sub-configuration. When the trigger/indication/activation state is activated, it indicates that the at least one sub-configuration in the CSI report configuration is triggered/indicated/activated, or it indicates that the CSI report configuration index is activated and the at least one sub-configuration in the CSI report configuration is triggered/indicated/activated.

For another example, one trigger/indication/activation state in the first trigger/indication/activation state list is associated with at least one piece of sub-configuration information, indicating that the at least one sub-configuration is triggered/indicated/activated.

For another example, one trigger/indication/activation state in the first trigger/indication/activation state list is associated with at least one CSI-RS resource index. For example, one CSI-RS Resource set includes a plurality of resources, each resource corresponding to one sub-configuration, i.e., a spatial domain/energy domain element adjustment mode, and one trigger/indication/activation state is associated with at least one CSI-RS resource index. When the trigger/indication/activation state is activated, it indicates that at least a corresponding sub-configuration is triggered/indicated/activated.

The above text schematically describes the CSI report configuration. The following text schematically describes the indication information.

In some embodiments, the indication information is downlink control information (DCI). The downlink control information (DCI) is user-specific (UE-specific), and the downlink control information is scrambled with a first RNTI. The first RNTI may be an RNTI related to network energy saving that is different from an SP-CSI-RNTI or a C-RNTI, or the first RNTI is an SP-CSI-RNTI or a C-RNTI.

For example, an RNTI dedicated to network energy saving may be newly defined, such as NES-RNTI, NES-SP-CSI-RNTI, etc. For how these RNTIs are specifically generated, relevant technologies may be referred to. These newly defined RNTIs may further be used for other functions. For another example, the first RNTI may further use an existing SP-CSI-RNTI or C-RNTI.

In some embodiments, the downlink control information (DCI) is of DCI format 0_1 or DCI format 0_2. A CSI request field and/or a first trigger/indication/activation field (which may be simply called a first indication field, such as sub-CSI indication field) in the downlink control information (DCI) is/are used to activate a CSI report and/or indicate at least one sub-configuration among the plurality of sub-configurations.

For example, the DCI format may reuse the existing DCI formats (0_1, 0_2), a DCI field may further reuse an existing CSI request field, and may further reuse other idle fields in the DCI formats. The first trigger/indication/activation field in the DCI is the CSI request field or other existing fields. A maximum value of a bit width of the CSI request field has been determined to be 6. A bit width of the DCI field determines the number of activation states in the first trigger/indication/activation state list. Or, the first trigger/indication/activation field is part of the CSI request field, and the first trigger/indication/activation field is simultaneously used for activation/deactivation of CSI and triggering/indication/activation of sub-configurations.

The first trigger/indication/activation state list configured via RRC is an existing IE (such as CSI-SemiPersistentOnPUSCH-TriggerStateList) or a newly defined IE (such as CSI-Semi PersistentOnPUSCH-TriggerStateList-r18), one trigger/indication/activation state in some trigger/indication/activation states in the list is associated with one CSI report configuration, and one trigger/indicator/activation state in some trigger/indicator/activation states is associated with one CSI report configuration and/or at least one sub-configuration.

If a trigger state indicated by the CSI request field is only associated with one CSI report configuration index, activation/deactivation of the CSI report is performed, and triggering/indication/activation of a sub-configuration is not performed.

If the trigger state indicated by the CSI request field is associated with the CSI report configuration and the sub-configuration, if the CSI report is not activated, activation of the CSI report is performed, and triggering/indication/activation of the sub-configuration in the CSI report configuration is performed. If the CSI report configuration has been activated, adjustment/update/re-indication of the sub-configuration of the CSI report configuration is performed, and an updated sub-configuration overrides previously indicated sub-configurations.

If the trigger state indicated by the CSI request field is only associated with sub-configurations, it means that there is only one CSI report configuration for configuring multiple sub-configurations. Based on CSI report configuration information of RRC, the terminal equipment and the network device are already aware of the index of the CSI report configuration including multiple sub-configurations. Therefore, the terminal equipment performs triggering/indication/activation of the sub-configurations.

For another example, the first trigger/indication/activation field of DCI is a newly defined field, such as CSI-request-r18, the newly defined field being used simultaneously for activation/deactivation of CSI reporting and triggering/indication/activation of sub-configurations. A field bit width may be larger, and may be used simultaneously for activation/deactivation of CSI and triggering/indication/activation of sub-configurations. The triggering/indication/activation of sub-configurations is flexible and unrestricted.

The first trigger/indication/activation state list configured via RRC is an existing IE (such as CSI-SemiPersistentOnPUSCH-TriggerStateList) or a newly defined IE (such as CSI-Semi PersistentOnPUSCH-TriggerStateList-r18), one trigger/indication/activation state in some trigger/indication/activation states in the list is associated with one CSI report configuration, and one trigger/indicator/activation state in some trigger/indicator/activation states is associated with one CSI report configuration and at least one sub-configuration.

If a trigger state indicated by CSI request-r18 is only associated with a CSI report configuration index: activation/deactivation of the CSI report is performed, and triggering/indication/activation of a sub-configuration is not performed.

If the trigger state indicated by CSI request-r18 is associated with the CSI report configuration and the sub-configuration: if the CSI report is not activated, activation of the CSI report is performed, and triggering/indication/activation of the sub-configuration in the CSI report configuration is performed. If the CSI report configuration has been activated, adjustment/update/re-indication of the sub-configuration of the CSI report configuration is performed, and an updated sub-configuration overrides previously indicated sub-configurations.

If the trigger state indicated by CSI request-r18 is only associated with sub-configurations: it means that there is only one CSI report configuration for configuring multiple sub-configurations. Based on CSI report configuration information of RRC, the terminal equipment and the network device are already aware of the index of the CSI report configuration including multiple sub-configurations. Therefore, the terminal equipment performs triggering/indication/activation of the sub-configurations in the CSI report configuration.

In the above examples, a list configured via RRC+a field in DCI are used for activation/deactivation of CSI and triggering/indication/activation of sub-configurations.

For another example, the first trigger/indication/activation field of DCI is a newly defined field. The existing CSI request field and the newly defined field jointly trigger/indicate/activate N1 sub-configurations in S sub-configurations of the CSI report configuration, wherein the CSI request field is used for activation/deactivation of a CSI report, the newly defined field is used to trigger/indicate/activate sub-configurations in indices of the CSI report configuration activated by a CSI request.

For example, a CSI request field+a newly defined DCI field, the newly defined DCI field is set to all zeros or an invalid value: activation/deactivation of the CSI is performed, and triggering/indication/activation of the sub-configurations is not performed.

For another example, a CSI request field+a newly defined DCI field, the newly defined DCI field is set to a non-zero value or valid value: if the CSI report is not activated, activation/deactivation of the CSI report is performed, and triggering/indication/activation of the sub-configurations are performed. If the CSI report has been activated, adjustment/update/re-indication of the sub-configuration of the CSI report configuration is performed, and an updated sub-configuration overrides previously indicated sub-configurations.

In the above examples, two lists may be configured via RRC: one is original CSI-SemiPersistentOnPUSCH-TriggerStateList, and the other is a newly defined list; two fields in DCI: one is the original CSI request field, and the other is a newly defined DCI field. The CSI request field is used for CSI activation/deactivation, and the newly defined DCI field is used for triggering/indication/activation of sub-configurations.

In some embodiments, for the PUSCH-based semi-persistent CSI reporting, according to a special field in the downlink control information (DCI), a CSI request field and/or a first trigger/indication/activation field (such as sub-CSI indication field) in the downlink control information (DCI) is/are used to activate/deactivate at least one CSI report and/or indicate at least one sub-configuration among the plurality of sub-configurations.

In some embodiments, the special fields in the downlink control information (DCI) are one or more existing fields in the DCI (such as HARQ process number and/or Redundancy Version, etc.), including semi-persistent CSI activation/deactivation PDCCH verification fields.

In some embodiments, the special field in the downlink control information (DCI) is a field related to network energy saving that is different from the semi-persistent CSI activation/deactivation PDCCH validation fields.

For example, a first special field for valid triggering/indicating/activating PDCCH verification is used to verify triggering/indication/activation of a PUSCH semi-persistent CSI sub-configuration. If the verification is achieved, the terminal equipment (UE) regards information in a DCI format as valid triggering/indication/activation of the PUSCH semi-persistent CSI sub-configuration. If the verification is not achieved, the UE considers that the DCI format has detected an unmatched CRC.

The first special field may be a semi-persistent CSI activation PDCCH validation field (such as HARQ process number and/or Redundancy version), continuing to use an existing CSI activation special field, as shown in Table 1. The first special field may be a newly defined field used to verify the triggering/indication/activation of a PUSCH semi-persistent CSI sub-configuration.

For another example, a first special field for valid releasing/stopping PDCCH verification is used to verify releasing/stopping a triggering/indication/activation command of a PUSCH semi-persistent CSI sub-configuration. If the verification is achieved, the terminal equipment (UE) regards information in a DCI format as valid releasing/stopping a triggering/indication/activation command of the PUSCH semi-persistent CSI sub-configuration. If the verification is not achieved, the UE considers that the DCI format has detected an unmatched CRC.

The first special field may be a semi-persistent CSI deactivation PDCCH validation field (such as HARQ process number and/or Modulation and coding scheme and/or Resource block assignment and/or Redundancy version), continuing to use an existing CSI deactivation special field, as shown in Table 2. The first special field may be a newly defined field used to verify releasing/stopping a triggering/indication/activation command of a PUSCH semi-persistent CSI sub-configuration.

Valid triggering/indication/activation and valid releasing of the PUSCH semi-persistent CSI sub-configuration may all have a special field, valid triggering/indication/activation of a special field and valid releasing/stopping of a special field may have the same configuration value, or may have different configuration values.

Or, valid triggering/indication/activation of the PUSCH semi-persistent CSI sub-configuration has a special field, valid releasing/stopping does not have a special field, i.e., there is no need to configure a special field for valid releasing/stopping. For example, CSI deactivation represents valid releasing/stopping of a triggered/indicated/activated sub-configuration.

Or, valid triggering/indication/activation of the PUSCH semi-persistent CSI sub-configuration and valid releasing do not have special fields, i.e., there is no need to configure special fields for them. At least in the following circumstance, valid triggering/indication/activation and valid releasing do not require special fields:

In a DCI, it is possible to both activate a semi-persistent CSI report configuration index and trigger/indicate/activate S sub-configurations in an activated CSI report configuration. In this situation, SP-CSI-RNTI is used to scramble the DCI, and the special field of the DCI is a special field of semi-persistent CSI activation PDCCH verification in an existing protocol; in case of CSI deactivation, the special field of the DCI is a special field of semi-persistent CSI deactivation PDCCH validation in the existing protocol, indicating valid releasing/stopping of a sub-configuration.

In some embodiments, a size/the number of bits of the first trigger/indication/activation field (such as sub-CSI indication field) in the downlink control information (DCI) is predefined, or configured via RRC signaling.

For example, when the first trigger/indication/activation field of the DCI is a newly defined DCI field, a first trigger/indication/activation size is used to determine a bit width of the first trigger/indication/activation field of the DCI. A method for determining the first trigger/indication/activation size may be as follows:

For example, it is determined by a predefined means, the first trigger/indication/activation size=X, where X is a positive integer greater than 0. For example, the first trigger/indication/activation size=8, i.e., the first trigger/indication/activation field of the DCI is 8 bits.

For another example, the first trigger/indication/activation size is configured via RRC and/or a maximum value of the first trigger/indication/activation size is configured via RRC. For example, the first trigger/indication/activation size is determined by a higher-layer parameter nes-ReportTriggerSize, and the maximum value of the first trigger/indication/activation size is determined by a higher-layer parameter max-nes-ReportTriggerSize.

For another example, the first trigger/indication/activation size is configured via RRC and/or the maximum value of the first trigger/indication/activation size is determined by a predefined means. For example, the maximum value of the first trigger/indication/activation size is predefined to be 6, the first trigger/indication/activation size is determined by a higher-layer parameter nes-ReportTriggerSize, nes-ReportTriggerSize may be configured as a positive integer greater than or equal to 0 and less than or equal to 6.

In some embodiments, the number of bits of the first trigger/indication/activation field is log₂X; X is the number of trigger (indication/activation) states. Bit values correspond to the trigger (indication/activation) states in a trigger state positional sequence.

For example, codepoints of the first trigger/indication/activation field in the downlink control information are mapped to the trigger (indication/activation) states in the trigger state positional sequence; wherein codepoint “0” or codepoint “1” is mapped to a trigger/indication/activation state at a first position.

For another example, the first trigger/indication/activation state list has X rows in total, each row corresponds to one trigger/indication/activation state. The bit width of the first trigger/indication/activation field of DCI is log₂X. According to a positional sequence of trigger states configured in the trigger/indication/activation state list, codepoints of the first trigger/indication/activation field of the DCI are mapped to the trigger/indication/activation states in the list, codepoint “0” or codepoint “1” is mapped to a trigger/indication/activation state at a first position.

In some embodiments, the first trigger/indication/activation field (sub-CSI indication field) in the downlink control information (DCI) is a bitmap. The number of bits of the first trigger/indication/activation field is X; X is the number of trigger/indication/activation states, or the number of sub-configurations in the CSI report configuration; wherein bit positions correspond to the trigger/indication/activation states or the sub-configurations sequentially. Bits from MSB to LSB in the bitmap correspond respectively to the first to the last trigger/indication/activation state in the first trigger/indication/activation state list, or the first to the last sub-configuration in the CSI report configuration; wherein 1 indicates triggering/indication/activation of a sub-configuration, and 0 indicates releasing/stopping/deactivation of a sub-configuration.

The above text schematically describes the DCI fields and mapping, and the following text will further describe through examples.

In some embodiments, for example the first trigger/indication/activation state list configured via RRC is an existing IE (such as CSI-SemiPersistentOnPUSCH-TriggerStateList) or a newly defined IE (such as CSI-SemiPersistentOnPUSCH-TriggerStateList-r18), one trigger/indication/activation state in the list is associated with one CSI report configuration and/or at least one sub-configuration, that is, part of the trigger/indication/activation states in the list is associated with a CSI report configuration index, and the other part of the trigger/indication/activation states is associated with a CSI report configuration index and/or at least one sub-configuration; a DCI format reuses existing DCI formats (0_1, 0_2), the first trigger/indication/activation field of the DCI is a CSI request field or a newly defined field (such as CSI request field-r18), existing DCI fields are reused, codepoint “0” or “1” is mapped to a trigger/indication/activation state at a first position.

For a case of SP-CSI activation, for example the terminal equipment receives DCI 0_1/0_2, if a DCI format is scrambled with an SP-CSI-RNTI, and special fields in DCI Format 0_1/0_2 correspond to semi-persistent CSI activation PDCCH validation special fields, the CSI request field or the newly defined field (such as CSI request field-r18) activates one trigger/indication/activation state, and the trigger/indication/activation state is associated with one CSI report configuration index, the terminal equipment activates the CSI report configuration.

For a case of SP-CSI deactivation, for example the terminal equipment receives DCI 0_1/0_2, if a DCI format is scrambled with an SP-CSI-RNTI, and special fields in DCI Format 0_1/0_2 correspond to semi-persistent CSI deactivation PDCCH validation special fields, the CSI request field or the newly defined field (such as CSI request field-r18) corresponds to one trigger/indication/activation state, and the trigger/indication/activation state is associated with one CSI report configuration index, the terminal equipment deactivates the CSI report configuration.

For a case of CSI activation+triggering/indication/activation of sub-configurations, for example the terminal equipment receives DCI Format 0_1/0_2, if a DCI format is scrambled with an SP-CSI-RNTI, and special fields in DCI Format 0_1 correspond to semi-persistent CSI activation PDCCH validation special fields, the CSI request field or the newly defined field (such as CSI request field-r18) corresponds to one trigger/indication/activation state, and the trigger/indication/activation state is associated with one CSI report configuration index and at least one sub-configuration, the terminal equipment activates the CSI report configuration, and triggers/indicates/activates the at least one sub-configuration in the CSI report configuration. CSI deactivation or triggering/indication/activation of sub-configurations next time represents valid releasing/stopping of current sub-configuration triggering/indication/activation information.

For a case of triggering/indication/activation of sub-configurations after CSI activation, for example the terminal equipment receives DCI format 0_1, if a DCI format is scrambled with an SP-CSI-RNTI, and special fields in DCI Format 0_1 are semi-persistent CSI activation PDCCH validation special fields, the CSI request field corresponds to one trigger/indication/activation state, and the trigger/indication/activation state is associated with one CSI report configuration index and at least one sub-configuration, if the CSI report configuration is activated by a DCI scrambled with an SP-CSI-RNTI at a previous moment, and a sub-configurations are triggered/indicated/activated at the same time of CSI activation, the terminal equipment triggers/indicates/activates the sub-configurations in the CSI report configuration at a current moment, sub-configuration triggering/indication/activation information this time overrides sub-configuration triggering/indication/activation information at the previous time. CSI deactivation or triggering/indication/activation of sub-configurations next time represents valid releasing/stopping of current sub-configuration triggering/indication/activation information.

For example, at T1 moment, the terminal equipment receives DCI format 0_1 scrambled with the SP-CSI-RNTI, the special field is a CSI semi-persistent CSI activation PDCCH verification special field, and the trigger/indication/activation state corresponding to the CSI request field is associated with {CSI report config1, 32 port CSI-RS sub-configuration, 16 port CSI-RS sub-configuration}, the terminal equipment activates CSI report config1 and indicates 32 port CSI-RS and 16 port sub-configuration.

At T2 moment, the terminal equipment receives DCI format 0_1 scrambled with the SP-CSI-RNTI, the special field is a CSI semi-persistent CSI activation PDCCH verification special field, and the trigger/indication/activation state corresponding to the CSI request field is associated with {CSI report config1, 8 port CSI-RS sub-configuration, 4 port CSI-RS sub-configuration}, and the terminal equipment determines that CSI report config1 has been activated, the terminal equipment re-indicates sub-configurations of CSI report config1 and updates/adjusts 32 port CSI-RS sub-configuration and 16 port sub-configuration to 8 port CSI-RS and 4 port CSI-RS sub-configurations.

For a case of re-triggering/indication/activation of sub-configurations after CSI activation, for another example the terminal equipment receives DCI format 0_1, if a DCI format is scrambled with an SP-CSI-RNTI, and special fields in DCI Format 0_1 are fields for triggering/indication/activation of sub-configurations that are different semi-persistent CSI activation/deactivation PDCCH validation special fields, the CSI request field or the newly defined field (such as CSI request field-r18) corresponds to one trigger/indication/activation state, and the trigger/indication/activation state is associated with one CSI report configuration index and at least one sub-configuration, if the CSI report configuration is activated by a DCI scrambled with an SP-CSI-RNTI at a previous moment, and a sub-configurations are triggered/indicated/activated at the same time of CSI activation, the terminal equipment triggers/indicates/activates the sub-configurations in the CSI report configuration at a current moment, sub-configuration triggering/indication/activation information this time overrides sub-configuration triggering/indication/activation information at the previous time. CSI deactivation or triggering/indication/activation of sub-configurations next time represents valid releasing/stopping of current sub-configuration triggering/indication/activation information.

For a case of triggering/indication/activation of sub-configurations after CSI activation, for another example the terminal equipment receives DCI format 0_1, if the DCI format is scrambled with a newly defined network energy-saving related RNTI, such as NES-RNTI, the CSI request field or the newly defined field (such as CSI request field-r18) corresponds to one trigger/indication/activation state, and the trigger/indication/activation state is associated with one CSI report configuration index and at least one sub-configuration, if the CSI report configuration is activated by a DCI scrambled with an SP-CSI-RNTI at a previous moment, and a sub-configurations are triggered/indicated/activated at the same time of CSI report activation, the terminal equipment triggers/indicates/activates the sub-configurations in the CSI report configuration at a current moment, sub-configuration triggering/indication/activation information this time overrides sub-configuration triggering/indication/activation information at the previous time. CSI deactivation or triggering/indication/activation of sub-configurations next time represents valid releasing/stopping of current sub-configuration triggering/indication/activation information.

Thereby, the CSI activation/deactivation and the triggering/indication/activation of sub-configurations share one RRC configuration list and DCI field, which can indicate multiple sub-configurations and multiple CSIs in a triggering/indication/activation mechanism of the DCI field, has higher indication flexibility and also can save DCI and RRC overhead.

In some embodiments, for example RRC configures the first trigger/indication/activation state list, the list is a newly defined IE, such as CSI-SemiPersistentOnPUSCH-subConfig-TriggerStateList or NES-sub-CSI-SemiPersistentOnPUSCH-TriggerStateList, one trigger/indication/activation state in the list is associated with one CSI report configuration index and/or at least one sub-configuration, and RRC configures CSI-SemiPersistentOn PUSCH-TriggerStateList. The DCI Format reuses existing DCI formats (0_1, 0_2), and the first trigger/indication/activation field of DCI is a newly defined DCI field. Existing CSI-SemiPersistentOnPUSCH-TriggerStateList and CSI request field are used for activation/deactivation of the CSI report, and the first trigger/indication/activation state list and the first trigger/indication/activation field are used for triggering/indication/activation of sub-configurations.

The first trigger/indication/activation field may be a codepoint with a bit width being log₂X, where X is the number of trigger/indication/activation states in the first trigger/indication/activation state list or the number of rows in the list, codepoint “0” or “1” is mapped to the trigger/indication/activation state at a first position sequentially according to an ascending order of the trigger/indication/activation state indices in the first trigger/indication/activation state list; or, the first trigger/indication/activation field (NES sub-CSI indication field) may further be a bitmap with a bit width of X, where X is the number of trigger/indication/activation states in the first trigger/indication/activation state list or the number of rows in the list, arranged in an ascending order of the trigger/indication/activation state indices in the first trigger/indication/activation state list, MSB to LSB in the bitmap correspond to the first to the last trigger/indication/activation states.

For a case of SP-CSI activation, for example the terminal equipment receives DCI Format 0_1, if the DCI format is scrambled with an SP-CSI-RNTI, and special fields in DCI Format 0_1 correspond to activation of semi-persistent CSI, the newly defined first trigger/indication/activation field (NES sub-CSI indication field) is all zero or an invalid value or other reference value, the terminal equipment performs a CSI activation operation and determines a CSI report needing to be activated according to the CSI request field.

For a case of SP-CSI deactivation, for example the terminal equipment receives DCI Format 0_1, if the DCI format is scrambled with an SP-CSI-RNTI, and special fields in DCI Format 0_1 correspond to deactivation of semi-persistent CSI, the newly defined DCI field (NES sub-CSI indication field) is all zero or an invalid value or other reference value, the terminal equipment performs a CSI deactivation operation and determines a CSI report needing to be deactivated according to the CSI request field.

For a case of SP-CSI activation+sub-configuration triggering/indication/activation, for example the terminal equipment receives DCI Format 0_1, if the DCI format is scrambled with an SP-CSI-RNTI, and special fields in DCI Format 0_1 correspond to activation of semi-persistent CSI, the newly defined first trigger/indication/activation field (NES sub-CSI indication field) is a non-zero valid value, the terminal equipment performs activation of the semi-persistent CSI report according to the CSI report configuration index corresponding to the CSI request field, and triggers/indicates/activates a sub-configuration according to the newly defined first trigger/indication/activation field (NES sub-CSI indication field), that is, triggers/indicates/activates the sub-configuration in the CSI report configuration activated in the CSI request field.

For a case of triggering/indication/activation of a sub-configuration after SP-CSI activation, for example the terminal equipment receives DCI Format 0_1, if the DCI format is scrambled with an SP-CSI-RNTI, and special fields in DCI Format 0_1 correspond to activation of semi-persistent CSI, the newly defined first trigger/indication/activation field (NES sub-CSI indication field) is a non-zero valid value. The terminal equipment obtains CSI report configuration indices according to the CSI request field, and triggers/indicates/activates the sub-configurations according to the newly defined first trigger/indication/activation field (NES sub-CSI indication field). If the CSI report configuration is activated by a DCI scrambled with an SP-CSI-RNTI at a previous moment, and the sub-configurations are triggered/indicated/activated at the same time of CSI report activation, the trigger/indication/activation information of the sub-configurations this time overrides the trigger/indication/activation information of the sub-configurations at a previous time. CSI deactivation or triggering/indication/activation of sub-configurations next time represents valid releasing/stopping of current sub-configuration triggering/indication/activation information.

For example, at T1 moment, the terminal equipment receives DCI Format 0_1 signaling scrambled with an SP-CSI-RNTI, the CSI request field corresponds to CSI report config 1, the newly defined first trigger/indication/activation field (NES sub-CSI indication field) indicates 32/16-port sub-configurations in the four 32/16/8/4-port sub-configurations, the special field is a CSI activation PDCCH verification special field, the terminal equipment performs activation of CSI report config 1 based on the signaling and triggers/indicates/activates two (32-port and 16-port sub-configurations) of the four sub-configurations.

At T2 moment, CSI report config 1 is still in an activation period, the terminal equipment receives DCI Format 0_1 signaling scrambled with an SP-CSI-RNTI, the CSI request field corresponds to CSI report config 1, the newly defined first trigger/indication/activation field (NES sub-CSI indication field) indicates 8-port sub-configuration in the four 32/16/8/4-port sub-configurations, the special field is a CSI activation PDCCH verification special field, the terminal equipment determines that one (8-port sub-configuration) of the four sub-configurations is triggered/indicated/activated based on the signaling, no processing is required for CSI activation.

For a case of triggering/indication/activation of a sub-configuration after SP-CSI activation, for another example the terminal equipment receives DCI Format 0_1, if the DCI format is scrambled with an SP-CSI-RNTI, and special fields in DCI Format 0_1 are fields for triggering/indication/activation of a sub-configuration that are different from semi-persistent CSI activation/deactivation PDCCH validation special fields, the newly defined first trigger/indication/activation field (NES sub-CSI indication field) is a non-zero valid value. The terminal equipment obtains CSI report configuration indices according to the CSI request field, and triggers/indicates/activates the sub-configurations according to the newly defined first trigger/indication/activation field (NES sub-CSI indication field). If the CSI report configuration is activated by a DCI scrambled with an SP-CSI-RNTI at a previous moment, and the sub-configurations are triggered/indicated/activated at the same time of CSI report activation, the trigger/indication/activation information of the sub-configurations this time overrides the trigger/indication/activation information of the sub-configurations at a previous time. CSI deactivation or triggering/indication/activation of sub-configurations next time represents valid releasing/stopping of current sub-configuration triggering/indication/activation information.

For a case of triggering/indication/activation of a sub-configuration after SP-CSI activation, for another example the terminal equipment receives DCI Format 0_1, if the DCI format is scrambled with a newly defined network energy-saving related RNTI, such as NES-RNTI, the newly defined first trigger/indication/activation field (NES sub-CSI indication field) is a non-zero valid value. The terminal equipment obtains CSI report configuration indices according to the CSI request field, and triggers/indicates/activates the sub-configurations according to the newly defined first trigger/indication/activation field (NES sub-CSI indication field). If the CSI report configuration is activated by a DCI scrambled with an SP-CSI-RNTI at a previous moment, and the sub-configurations are triggered/indicated/activated at the same time of CSI report activation, the trigger/indication/activation information of the sub-configurations this time overrides the trigger/indication/activation information of the sub-configurations at a previous time. CSI deactivation or triggering/indication/activation of sub-configurations next time represents valid releasing/stopping of current sub-configuration triggering/indication/activation information.

In some embodiments, the terminal equipment receives first DCI scrambled by an SP-CSI-RNTI, a CSI request field of the first DCI is associated with a semi-persistent CSI report having the same identification as the CSI report configuration, and the semi-persistent CSI report is activated by previously received second DCI scrambled by the SP-CSI-RNTI, the first DCI is used to re-trigger/indicate/activate the sub-configuration during activation of the semi-persistent CSI report.

In some embodiments, information on triggering/indicating/activating of the sub-configuration for a next time overrides triggering/indication/activation of sub-configuration for a previous time; after the semi-persistent CSI report is deactivated, the information on triggering/indicating/activating the sub-configuration is released/stopped/deactivated.

According to the provisions of an existing protocol, a UE is not expected to receive a DCI scrambled with SP-CSI-RNTI activating one semi-persistent CSI report with the same CSI-ReportConfigId as in a semi-persistent CSI report which is activated by a previously received DCI scrambled with SP-CSI-RNTI.

In the above embodiments, a UE may receive DCI scrambled with an SP-CSI-RNTI, a CSI request field of the DCI is associated with a semi-persistent CSI report with the same CSI-ReportConfigId, while the semi-persistent CSI report is activated by previously received DCI scrambled with the SP-CSI-RNTI. The transmission behavior is not for activation of the semi-persistent CSI report, but for re-triggering/indication/activation of sub-configurations during activation of a CSI report. Thereby, in the trigger/indication/activation mechanism of the DCI field, multi-sub-configuration/multi-CSIs may be indicated each time, the indication flexibility is relatively high. Moreover, the DCI field has fewer bits, the overhead is low.

In some embodiments, the CSI report configuration is associated with L pieces of CSI, and the CSI reporting includes S sub-configurations, such as sub-config1 to sub-config 1 or codebook config 1 to codebook config 1, one sub-configuration corresponding to one CSI, S=L. The first trigger/indication/activation state list is S sub-configurations of the CSI report configuration, X=S=L. A DCI format reuses existing DCI formats (0_1, 0_2), the first trigger/indication/activation field of DCI is a newly defined DCI field, existing CSI-Semi PersistentOnPUSCH-TriggerStateList and CSI request field are used for activation/deactivation of the CSI report, the list of S sub-configurations in the CSI report configuration and the first trigger/indication/activation field are used for triggering/indication/activation of the sub-configurations.

The first trigger/indication/activation field may be a codepoint with a bit width being log 2X, where X is the number of trigger/indication/activation states in the first trigger/indication/activation state list or the number of rows in the list, codepoint “0” or “1” is mapped to the trigger/indication/activation state at a first position sequentially according to an ascending order of the trigger/indication/activation state indices in the first trigger/indication/activation state list; or, the first trigger/indication/activation field (NES sub-CSI indication field) may further be a bitmap with a bit width of X, where X is the number of trigger/indication/activation states in the first trigger/indication/activation state list or the number of rows in the list, arranged in an ascending order of the trigger/indication/activation state indices in the first trigger/indication/activation state list, MSB to LSB in the bitmap correspond to the first to the last trigger/indication/activation states.

The above text schematically describes the situations for PUSCH semi-persistent CSI reporting. For example, a set of trigger/indication/activation states is configured by the first trigger/indication/activation state list configured by a higher layer, wherein the first trigger/indication/activation field in the DCI is combined with the first RNTI to trigger/indicate/activate at least one of the trigger states. According to the first mapping mode, the first trigger/indication/activation field of DCI is mapped to the trigger/indication/activation states in the first trigger/indication/activation state list configured by the higher layer.

For example, the first trigger/indication/activation state list is used to configure/indicate a CSI report configuration and/or sub-configuration of a terminal equipment. Each row in the first trigger/indication/activation state list is a trigger/indication/activation state, with a total of X rows, i.e., X trigger/indication/activation states. Each trigger state is or is associated with at least one CSI report configuration and/or at least one sub-configuration.

The first trigger/indication/activation field in the DCI is combined with the first RNTI to trigger/indicate/activate at least one of the trigger states, that is, to trigger/indicate/activate the CSI report configuration and/or N1 sub-configurations in the S sub-configurations. A bit width of the first trigger/indication/activation field is determined by a first trigger/indication/activation size.

For triggering/indication/activation of a PUSCH semi-persistent CSI sub-configuration, a UE will verify PDCCHs on the DCI only when the following conditions are met: a CRC parity check bit in a DCI format is scramble with the first RNTI provided by the higher layer, and/or, the DCI-format special field is a first special field configuration.

If verification is implemented, the UE regards the information in the DCI format as valid triggering/indication/activation and/or valid releasing/stopping of the PUSCH semi-persistent CSI sub-configuration, and the UE triggers/indicates/activates or stops/releases sub-configuration settings indicated by the first trigger/indication/activation field in the DCI. If the verification is not implemented, the UE considers that the DCI format has detected an unmatched CRC.

The following text schematically describes the situations for PUSCH aperiodic CSI reporting, contents same as the above text are omitted. A second trigger/indication/activation state list, a second trigger/indication/activation field, a second mapping mode, etc. described below may be referred to the first trigger/indication/activation state list, the first trigger/indication/activation filed, and the first mapping mode described above.

For example, a set of trigger/indication/activation states is configured by the second trigger/indication/activation state list configured by a higher layer, wherein the second trigger/indication/activation field in the DCI triggers/indicates/activates at least one of the trigger states. According to the second mapping mode, the second trigger/indication/activation field of DCI is mapped to the trigger/indication/activation states in the second trigger/indication/activation state list configured by the higher layer.

In some embodiments, the second trigger/indication/activation state list for PUSCH aperiodic CSI reporting is an existing IE or a newly defined IE, one trigger (indication/activation) state in the list is associated with at least one CSI report configuration index and/or at least one sub-configuration. That is, one trigger (indication/activation) state in the list includes one associated report configuration list (associatedReportConfigInfoList) and one associated sub-configuration list (associatedSubConfigInfoList); or one trigger (indication/activation) state in the list is associated with at least one CSI report configuration, i.e., one trigger (indication/activation) state in the list includes one associated report configuration list (associatedReportConfigInfoList), the report configuration at list being least one associated report configuration (associatedReportConfigInfo), one associated report configuration in the at least one associated report configuration is associated with at least one sub-configuration, i.e., one associated report configuration in the at least one associated report configuration includes one associated sub-configuration list, such as associatedSubConfigInfoList.

The second trigger/indication/activation state list for PUSCH aperiodic CSI reporting is used for configuring a set of trigger/indication/activation states, one trigger/indication/activation state in the list is associated with at least one CSI report configuration index and/or at least one sub-configuration. Or, one trigger (indication/activation) state in the list is associated with at least one CSI report configuration, i.e., one trigger (indication/activation) state in the list includes at least one piece of associated report configuration information, the associated report configuration information may be associated with at least one sub-configuration, i.e., one associated sub-configuration list is included under the associated report configuration information.

In some embodiments, the second trigger/indication/activation state list for PUSCH aperiodic CSI reporting is S sub-configurations in the CSI report configuration, each trigger/indication/activation state in the list is a sub-configuration, where X=S; for example, sub-config1 to sub-config S or codebook config 1 to codebook config S in the CSI report configuration are S sub-configurations.

In some embodiments, the second trigger/indication/activation state list for PUSCH aperiodic CSI reporting may reuse an existing IE, such as CSI-AperiodicTriggerStateList, or may be a newly defined IE, such as CSI-AperiodicTriggerStateList-r18, each trigger state may be associated with at least one CSI report configuration and/or at least one sub-configuration. Or, one trigger (indication/activation) state is associated with at least one CSI report configuration, i.e., one trigger (indication/activation) state in the list includes at least one piece of associated report configuration information, the associated report configuration information may be associated with at least one sub-configuration, i.e., one associated sub-configuration list is included under the associated report configuration information.

The sub-configuration information may be a sub-configuration (index), a codebook configuration (index), port subset indication information (index), an n1-n2 configuration (index), etc. Each sub-configuration-related parameter is associated with one spatial domain/energy domain adjustment element mode.

Table 8 shows an example of a trigger/indication/activation state list for PUSCH aperiodic CSI reporting.

TABLE 8

| | |
|---|---|
| CSI-AperiodicTriggerStateList ::= | SEQUENCE (SIZE (1..maxNrOfCSI-AperiodicTriggers)) OF |

CSI-AperiodicTriggerState

| | |
|---|---|
| CSI-AperiodicTriggerState ::= | SEQUENCE { |
| associatedReportConfigInfoList | SEQUENCE |

```
(SIZE(1..maxNrofReportConfigPerAperiodicTrigger)) OF CSI-AssociatedReportConfigInfo,
    ...,
    [[
```

| | |
|---|---|
| ap-CSI-MultiplexingMode-r17 | ENUMERATED {enabled} |

OPTIONAL -- Need R
]]
}

| | |
|---|---|
| CSI-AssociatedReportConfigInfo ::= | SEQUENCE { |
| reportConfigId | CSI-ReportConfigId, |
| resourcesForChannel | CHOICE { |
| nzp-CSI-RS | SEQUENCE { |
| resourceSet | INTEGER (1..maxNrofNZP-CSI-RS- |

ResourceSetsPerConfig),

| | |
|---|---|
| qcl-info | SEQUENCE (SIZE(1..maxNrofAP-CSI-RS- |

ResourcesPerSet)) OF TCI-StateId
OPTIONAL -- Cond Aperiodic
},

| | |
|---|---|
| csi-SSB-ResourceSet | INTEGER (1..maxNrofCSI-SSB- |

ResourceSetsPerConfig)
},

| | |
|---|---|
| csi-IM-ResourcesForInterference | INTEGER(1..maxNrofCSI-IM-ResourceSetsPerConfig) |

OPTIONAL, -- Cond CSI-IM-ForInterference
nzp-CSI-RS-ResourcesForInterference INTEGER (1..maxNrofNZP-CSI-RS-

| | |
|---|---|
| ResourceSetsPerConfig) | OPTIONAL, -- Cond NZP-CSI-RS-ForInterference |

```
    ...,
    [[
```

| | |
|---|---|
| resourcesForChannel2-r17 | CHOICE { |
| nzp-CSI-RS2-r17 | SEQUENCE { |
| resourceSet2-r17 | INTEGER (1..maxNrofNZP-CSI-RS- |

ResourceSetsPerConfig),

| | |
|---|---|
| qcl-info2-r17 | SEQUENCE (SIZE(1..maxNrofAP-CSI-RS- |

ResourcesPerSet)) OF TCI-StateId
OPTIONAL -- Cond Aperiodic
},

| | |
|---|---|
| csi-SSB-ResourceSet2-r17 | INTEGER (1..maxNrofCSI-SSB- |

ResourceSetsPerConfigExt)
}
OPTIONAL, -- Cond NoUnifiedTCI

| | |
|---|---|
| csi-SSB-ResourceSetExt | INTEGER (1..maxNrofCSI-SSB-ResourceSetsPerConfigExt) |

OPTIONAL -- Need R
]]

| | |
|---|---|
| associatedSubConfigInfoList | SEQUENCE |

(SIZE(1..maxNrofSubConfigPerAperiodicTrigger)) OF CSI-AssociatedSubConfigInfo,
}

| | |
|---|---|
| CSI- AssociatedSubConfigInfo ::= | SEQUENCE { |
| associatedReportConfigInfoList | sub-config Id, |

...,

For example, the first trigger/indication/activation state list based on PUSCH semi-persistent CSI reporting and the second trigger/indication/activation state list based on PUSCH aperiodic CSI reporting may be the same list, that is, one list contains both semi-persistent CSI reporting information and aperiodic CSI reporting information.

In some embodiments, the second trigger/indication/activation field of the DCI is used to indicate at least one trigger/indication/activation state in the second trigger/indication/activation state list configured via RRC, and is used for activation/deactivation of a CSI report and/or triggering/indication/activation of a sub-configuration.

For example, existing DCI formats (0_1, 0_2) may be reused to reproduce an existing DCI field (CSI request); the second trigger/indication/activation field of DCI is a CSI request field.

For another example, the second trigger/indication/activation field of DCI is a newly defined DCI field. Existing CSI request field is used for the activation/deactivation of a CSI report, and the newly defined DCI field is used for the triggering/indication/activation of sub-configurations.

For another example, the first trigger/indication/activation field of DCI based on PUSCH semi-persistent CSI reporting and the second trigger/indication/activation field of DCI based on PUSCH aperiodic CSI reporting may be the same DCI field, i.e., are distinguished by scrambling with different RNTIs, it is aperiodic CSI reporting when being scrambled with a C-RNTI, and is semi-persistent CSI reporting when being scrambled with an SP-CSI-RNTI; or, the first trigger/indication/activation field of DCI based on PUSCH semi-persistent CSI reporting and the second trigger/indication/activation field of DCI based on PUSCH aperiodic CSI reporting may be different DCI fields.

In some embodiments, the second trigger/indication/activation state list configured via RRC is an existing IE (such as CSI-AperiodicTriggerStateList) or a newly defined IE (such as CSI-AperiodicTriggerStateList-r18), one trigger/indication/activation state in the list is associated with at least one CSI report configuration and/or at least one sub-configuration, that is, part of the trigger/indication/activation states in the list is only associated with a CSI report configuration index, and the other part of the trigger/indication/activation states is associated with the CSI report configuration index and/or a sub-configuration; existing DCI formats (0_1, 0_2) may be reused, the second trigger/indication/activation field of the DCI is a CSI request field or a newly defined DCI field (such as CSI request field-r18), the second trigger/activation/indication state list and the second trigger/activation/indication field are used for the activation of CSI reports and the triggering/indication/activation of sub-configurations. The bit width of the newly defined second trigger/indication/activation field is log₂X. codepoint “0” or “1” is mapped to the trigger/indication/activation state at the first position, where X is the number of trigger/indication/activation states in the first trigger/indication/activation state list or the number of rows in the list.

For a case of AP-CSI activation, for example the terminal equipment receives DCI format 0_1, the newly defined DCI field (NES sub-CSI indication field) is all zero or an invalid value, the terminal equipment determines a CSI report needing to be activated according to the CSI request field.

For a case of AP-CSI activation+sub-configuration triggering/indication/activation, for example the terminal equipment receives DCI format 0_1, the newly defined DCI field (NES sub-CSI indication field) is a non-zero valid value, the terminal equipment performs activation of the semi-persistent CSI reporting according to the CSI report configuration index corresponding to the CSI request field, and triggers/indicates/activates a sub-configuration according to the newly defined DCI field (NES sub-CSI indication field).

In some embodiments, for example RRC configures the second trigger/indication/activation state list, the list is a newly defined IE, such as CSI-Aperiodic-subConfig-TriggerStateList or NES-sub-CSI-AperiodicOnPUSCH-Trigger StateList, two trigger/indication/activation states in the list are associated with a CSI report configuration index and/or at least one sub-configuration, and RRC configures CSI-AperiodicOnPUSCH-TriggerStateList; DCI Format reuses existing DCI formats (0_1, 0_2), and the second trigger/indication/activation field of DCI is a newly defined DCI field; existing CSI-AperiodicOnPUSCH-TriggerStateList and CSI request field are used for the activation of CSI reports, the second trigger/indication/activation state list and the second trigger/indication/activation field are used for triggering/indication/activation of sub-configurations. The second trigger/indication/activation field may be a codepoint with a bit width being log 2X, where X is the number of trigger/indication/activation states in the first trigger/indication/activation state list or the number of rows in the list, codepoint “0” or “1” is mapped to the trigger/indication/activation state at a first position sequentially according to an ascending order of the trigger/indication/activation state indices in the second trigger/indication/activation state list; or, the second trigger/indication/activation field (NES sub-CSI indication field) may further be a bitmap with a bit width of X, where X is the number of trigger/indication/activation states in the first trigger/indication/activation state list or the number of rows in the list, arranged in an ascending order of the trigger/indication/activation state indices in the second trigger/indication/activation state list, MSB to LSB in the bitmap correspond to the first to the last trigger/indication/activation states.

For a case of AP-CSI activation, for example the terminal equipment receives DCI format 0_1, the newly defined DCI field (NES sub-CSI indication field) is all zero or an invalid value, the terminal equipment determines a CSI report needing to be activated according to the CSI request field.

For a case of AP-CSI activation+sub-configuration triggering/indication/activation, for example the terminal equipment receives DCI format 0_1, the newly defined DCI field (NES sub-CSI indication field) is a non-zero valid value, the terminal equipment performs activation of the semi-persistent CSI reporting according to the CSI report configuration index corresponding to the CSI request field, and triggers/indicates/activates a sub-configuration according to the newly defined DCI field (NES sub-CSI indication field).

In some embodiments, the CSI report configuration is associated with L pieces of CSI, and the CSI reporting includes S sub-configurations, such as sub-config1 to sub-config 1 or codebook config 1 to codebook config 1, one sub-configuration corresponds to one CSI, S=L; the second trigger/indication/activation state list is S sub-configurations of the CSI report configuration, X=S=L; DCI format reuses existing DCI formats (0_1, 0_2), the second trigger/indication/activation field of DCI is a newly defined DCI field, existing CSI-AperiodicOnPUSCH-TriggerStateList and CSI request field are used for activation of CSI reports, the list of S sub-configurations in the CSI report configuration and the second trigger/indication/activation field is used for triggering/indication/activation of sub-configurations. The second trigger/indication/activation field may be a codepoint with a bit width being log 2X, where X is the number of trigger/indication/activation states in the first trigger/indication/activation state list or the number of rows in the list, codepoint “0” or “1” is mapped to the trigger/indication/activation state at a first position sequentially according to an ascending order of the trigger/indication/activation state indices in the first trigger/indication/activation state list; or, the second trigger/indication/activation field (NES sub-CSI indication field) may further be a bitmap with a bit width of X, where X is the number of trigger/indication/activation states in the second trigger/indication/activation state list or the number of rows in the list, arranged in an ascending order of the trigger/indication/activation state indices in the second trigger/indication/activation state list, MSB to LSB in the bitmap correspond to the first to the last trigger/indication/activation states.

For a case of AP-CSI activation, for example the terminal equipment receives DCI format 0_1, the newly defined DCI field (NES sub-CSI indication field) is all zero or an invalid value, the terminal equipment determines a CSI report needing to be activated according to the CSI request field.

For a case of AP-CSI activation+sub-configuration triggering/indication/activation, for example the terminal equipment receives DCI format 0_1, the newly defined DCI field (NES sub-CSI indication field) is a non-zero valid value, the terminal equipment performs activation of the semi-persistent CSI reporting according to the CSI report configuration index corresponding to the CSI request field, and triggers/indicates/activates a sub-configuration according to the newly defined DCI field (NES sub-CSI indication field).

The following text schematically describes situations of group common signaling.

In some embodiments, the downlink control information (DCI) is group common signaling, the downlink control information being scrambled by a second RNTI. The group common signaling includes a plurality of blocks, each block corresponding to one terminal equipment. The group common signaling is used to trigger/indicate/activate a sub-configuration of at least one terminal equipment.

In some embodiments, the block is used to indicate the CSI report configuration index and/or at least one sub-configuration of the terminal equipment, the sub-configuration is indicated using codepoints or a bitmap in the block, bit numeric values/positions correspond to the trigger (indication/activation) states sequentially. A bit width of the block is related to the number of sub-configurations and/or a bit width of the CSI report configuration index of the terminal equipment.

For example, DCI Format 2_X is used to notify one or more terminal equipments of information of N sub-configurations in L sub-configurations in the CSI report configuration, where N<L, each sub-configuration being associated with one CSI, and the terminal equipment reports N pieces of CSI based on DCI Format 2_X.

For example, the following information adopts DCI Format 2_X, the CRC is transmitted by being scrambled with a second RNTI (such as nes-RNTI): Block 1, block 2, . . . . Block N.

In some embodiments, the second RNTI is determined according to a first parameter, and a payload size of the downlink control information is determined according to a fourth parameter; a starting position of corresponding block information of the terminal equipment in the downlink control information (DCI) is determined according to a second parameter; a bit width of a corresponding block of the terminal equipment in the downlink control information (DCI) is determined according to a third parameter; and a bit width of the CSI report configuration index of the terminal equipment is determined according to a fifth parameter.

For example, a starting position of a block is determined by the second parameter (such as nes-PositionDCI-2-6) configured by a higher layer for the terminal equipment. If the terminal equipment is configured with the second RNTI (such as nes-RNTI) and dci-Format2-X via the higher layer, the higher layer configures a block for the terminal equipment, the field content of this block includes at least one of the following contents:
CSI report configuration index—Ybit, where Y is determined in a predefined manner, for example Y=2; or a size of Y is determined by a fifth parameter of the higher layer;
Sub-configuration trigger/indication/activation indication—a bit width of a bitmap is determined according to a third parameter of the higher layer, wherein each bit corresponds to one sub-configuration, and is arranged in an ascending order of sub-configuration indices in the CSI report configuration, MSB to LSB of the bitmap correspond to the first to the last configurations, where 1 indicates activation, and 0 indicates deactivation.

A size of DCI Format 2_X is indicated by a fourth parameter (such as sizeDCI-2-X) of the higher layer. DCI Format 2_X is used for the terminal equipment to monitor DCI Format 2_X, for example DCI Format 2_X is related to network energy saving and/or the CSI report configuration including L sub-configurations; wherein X may be a positive integer greater than 6.

In some embodiments, the first parameter is an RNTI value of a DCI format 2-X with CRC is scrambled for network energy saving. The second parameter is a starting position indicated by a CSI report configuration index and/or a sub-configuration trigger/indication/activation in DCI format 2-X. The third parameter is used to indicate a bit width of sub-configuration trigger/indication/activation indication information, i.e., the number of sub-configurations, each bit corresponding to one sub-configuration. The fourth parameter is used to indicate a size of DCI Format 2_X. The fifth parameter is used to determine a size of the Y.

In some embodiments, the terminal equipment configured with a network energy saving function may detect DCI format 2_X in PDCCH reception. For example, the terminal equipment determines an RNTI of DCI format 2_X based on the first parameter; monitors PDCCHs via DCI format 2-X, and to monitor DCI format 2_X on an active DL BWP of a PCell or SpCell; determines a payload size of DCI format 2_X based on the fourth parameter; determines a position of information of the terminal equipment in DCI format 2_X based on the second parameter; determines a size of Y based on the fifth parameter or a predefined rule, the first Y bits being used to determine a CSI report configuration index, and when a value of Y determined by the fifth parameter is 0, it indicates that there is no CSI report configuration index information in a current DCI format; and determines a bit width of a bitmap based on the third parameter, that is, determines the number of sub-configurations in the CSI report configuration. The position of the bitmap is after the CSI report configuration index information (if the CSI report configuration index information is configured), the size of the bitmap is equal to the number of sub-configurations, each bit corresponding to one sub-configuration. In the bitmap, “1” indicates that a sub-configuration is activated, and “0” indicates that it is deactivated.

The following text then describes the situations of PUCCH semi-persistent CSI reporting. The contents same as above are omitted. The following third trigger/indication/activation state list, etc. may refer to the aforementioned first trigger/indication/activation state list.

In some embodiments, the channel state information (CSI) report configuration is for a physical uplink control channel (PUCCH) semi-persistent CSI reporting. The indication information is a media access control (MAC) control element (CE), the MAC CE activates or deactivates at least one sub-configuration in the plurality of sub-configurations.

For example, a trigger/indication/activation MAC CE of the sub-configuration of the PUCCH semi-persistent CSI report configuration may be identified by a MAC sub-header with an LCID. For example, there is a fixed bit width, a size of the bit width is a first bit width parameter, which includes the following fields:
a serving cell ID: this field indicates an identifier of a serving cell in which the MAC CE is applied. A field length is 5 bits;
a BWP ID: this field indicates an UL BWP in which the MAC CE is applied, and serves as a codepoint of a DCI bandwidth part indication field. A length of the BWP ID field is 2 bits;
Sᵢ: indicating a state of triggering/indicating/activating and releasing/stopping/deactivating sub-configurations in the third trigger/indication/activation list for semi-persistent CSI reporting carried by a PUCCH. S₀ indicates that a sub-configuration has the lowest CSI-ReportConfigId in the third trigger/indicator/activation list. S₁ indicates that a sub-configuration has the second lowest CSI-ReportConfigId in the third trigger/indicator/activation list, and so on. If the number of sub-configurations in the third trigger/indicator/activation list is less than i+1, the MAC entity will ignore the Si field. Setting the Si field to 1 indicates that a sub-configuration configured by a corresponding semi-persistent CSI report configuration will be triggered/indicated/activated. Setting the Si field to 0 indicates that a sub-configuration configured by a corresponding semi-persistent CSI report configuration will be released/stopped/deactivated.
R: a reserved bit, which is set to 0.

The first bit width parameter may be determined in a predefined manner, for example the first bit width parameter=X, X=16; or, the first bit width parameter may be determined via an RRC higher-layer parameter.

In some embodiments, a third trigger/indication/activation list is configured via RRC, a row in the third trigger/indication/activation list corresponds to one CSI report configuration index and/or at least one CSI-RS resource index or at least one sub-configuration.

For example, the third trigger/indication/activation state list for PUCCH semi-persistent CSI reporting is S sub-configurations in the CSI report configuration, each row in the list is one sub-configuration, where X=S. For example, sub-config1 to sub-config S or codebook config 1 to codebook config S in the CSI report configuration are S sub-configurations.

For another example, the third trigger/indication/activation state list for PUCCH semi-persistent CSI reporting reuses an existing IE, such as CSI-reportconfigtoaddmodlist or partial CSI-reportconfigtoaddmodlist, each row in the list is at least one sub-configuration, where X=S.

For a further example, the trigger/indication/activation (state) list for PUCCH semi-persistent CSI reporting is a newly defined IE, such as NES-sub-CSI-SemipersistentOn PUCCHList, each row may be one sub-configuration, where X=S.

Each of the above embodiments is only illustrative for the present disclosure, but the present disclosure is not limited to this, appropriate modifications may be further made based on the above each embodiment. For example, each of the above embodiments may be used individually, or one or more of the above embodiments may be combined.

As may be known from the above embodiments, even in some scenarios (such as an energy-saving mode) of wireless communication applications, a network device is still able to indicate CSI to a terminal equipment efficiently and accurately, thereby the terminal equipment is able to transmit a CSI report efficiently and accurately, CSI reporting overhead can be saved and uplink resources can be saved.

### Embodiments of a Second Aspect

Embodiments of the present disclosure provide a method for indicating channel state information, which is described from a network device side. Embodiments of the second aspect may be combined with the embodiments of the first aspect, the same contents as the embodiments of the first aspect are not repeated.

FIG. 5 is a schematic diagram of a method for indicating channel state information in the embodiments of the present disclosure. As shown in FIG. 5, the method includes:
501, a network device transmits a channel state information (CSI) report configuration, the channel state information (CSI) report configuration being related to L pieces of CSI, the channel state information (CSI) report configuration including S sub-configurations, where 1≤S≤L, one of the S sub-configurations corresponds to at least one piece of channel state information (CSI); and
502, the network device transmits indication information, the indication information being used to trigger (indicate/activate) at least one of the S sub-configurations.

It should be noted that the above FIG. 5 only schematically describes the embodiments of the present disclosure, but the present disclosure is not limited thereto. For example, an execution step of each operation may be adjusted appropriately, moreover other some operations may be added or one or more operations may be removed. Persons skilled in the art may make appropriate modifications according to the above contents, not limited to the records in the above FIG. 5.

Each of the above embodiments is only illustrative for the present disclosure, but the present disclosure is not limited to this, appropriate modifications may be further made based on the above each embodiment. For example, each of the above embodiments may be used individually, or one or more of the above embodiments may be combined.

As may be known from the above embodiments, even in some scenarios (such as an energy-saving mode) of wireless communication applications, a network device is still able to indicate CSI to a terminal equipment efficiently and accurately, thereby the terminal equipment is able to transmit a CSI report efficiently and accurately, CSI reporting overhead can be saved and uplink resources can be saved.

### Embodiments of a Third Aspect

Embodiments of the present disclosure provide an apparatus for indicating channel state information. The apparatus for example may be a terminal equipment, or may be one or more parts or components configured in the terminal equipment, contents same as the embodiments of the first aspect are not repeated.

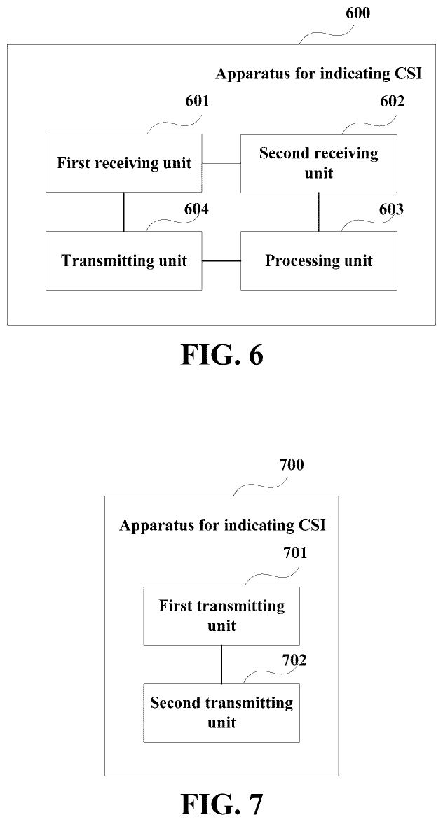

FIG. 6 is a schematic diagram of an apparatus for indicating channel state information in the embodiments of the present disclosure. As shown in FIG. 6, the apparatus 600 for indicating channel state information includes:
a first receiving unit 601, configured to receive a channel state information (CSI) report configuration, the channel state information (CSI) report configuration being related to L pieces of CSI, the channel state information (CSI) report configuration including S sub-configurations, where 1≤S≤L, one of the S sub-configurations corresponds to at least one piece of channel state information (CSI); and
a second receiving unit 602, configured to receive indication information, the indication information being used to trigger (indicate/activate) at least one of the S sub-configurations.

In some embodiments, the number of PUSCH-based semi-persistent CSI report configurations that include at least one sub-configuration is P, and/or, the number of PUSCH-based aperiodic CSI report configurations that include at least one sub-configuration is Q, and/or, the number of PUCCH-based semi-persistent CSI report configurations that include at least one sub-configuration is R, where P, Q and R are positive integers.

In some embodiments, as shown in FIG. 6, the apparatus may further include:
a processing unit 603, configured to perform channel measurement according to triggered (indicated/activated) M sub-configurations in S sub-configurations; and
a transmitting unit 604, configured to transmit a channel state information (CSI) report, the channel state information (CSI) report including N pieces of channel state information (CSI); wherein the M sub-configurations correspond to N pieces of channel state information, 1≤M≤N.

In some embodiments, the one sub-configuration includes at least one of the following information: parameter N1; parameter N2; parameter Ng; a codebook subset restriction; port information, the port information being used to indicate partial ports of channel state information reference signal (CSI-RS) resources associated with the channel state information (CSI) report configuration;
the sub-configuration is included in sub-configuration information (sub-config) of the channel state information (CSI) report configuration, or is included in codebook configuration information (codebook config) of the channel state information (CSI) report configuration, or is included in parameter configuration information (N1-N2 config) of the channel state information (CSI) report configuration.

In some embodiments, the channel state information (CSI) report configuration is for a physical uplink shared channel (PUSCH) semi-persistent CSI reporting; and a first trigger/indication/activation state list is configured via RRC, the first trigger/indication/activation state list including a set of X1 trigger (indication/activation) states;
or, the channel state information (CSI) report configuration is for a physical uplink shared channel (PUSCH) aperiodic CSI reporting; and a second trigger/indication/activation state list is configured via RRC, the second trigger/indication/activation state list including a set of X2 trigger (indication/activation) states;
wherein one trigger (indication/activation) state is associated with at least one CSI report configuration index and/or at least one CSI-RS resource index and/or at least one sub-configuration.

In some embodiments, the indication information is downlink control information (DCI);
the downlink control information (DCI) is user-specific (UE-specific), and the downlink control information is scrambled by a first RNTI; wherein the first RNTI is an RNTI related to network energy saving that is different from an SP-CSI-RNTI or a C-RNTI, or the first RNTI is an SP-CSI-RNTI or a C-RNTI.

In some embodiments, the downlink control information (DCI) is of DCI format 0_1 or DCI format 0_2; a CSI request field and/or a first indication field (sub-CSI indication field) in the downlink control information (DCI) is/are used to activate at least one CSI report and/or indicate at least one sub-configuration among the plurality of sub-configurations.

In some embodiments, for the PUSCH-based semi-persistent CSI reporting, according to a special field in the downlink control information (DCI), a CSI request field and/or a first indication field (sub-CSI indication field) in the downlink control information (DCI) is/are used to activate/deactivate at least one CSI report and/or indicate at least one sub-configuration among the plurality of sub-configurations.

In some embodiments, the special fields in the downlink control information (DCI) are one or more existing fields in the DCI, including semi-persistent CSI activation/deactivation PDCCH verification fields;
or, the special field in the downlink control information (DCI) is a field related to network energy saving that is different from the semi-persistent CSI activation/deactivation PDCCH validation fields.

In some embodiments, the second receiving unit 602 further receives first DCI scrambled by an SP-CSI-RNTI, a CSI request field of the first DCI is associated with a semi-persistent CSI report having the same identification as the CSI report configuration, and the semi-persistent CSI report is activated by previously received second DCI scrambled by the SP-CSI-RNTI, the first DCI is used to re-trigger/indicate/activate the sub-configuration during activation of the semi-persistent CSI report.

In some embodiments, information on re-triggering/indicating/activating the sub-configuration overrides triggering/indication/activation of a previous sub-configuration; after the semi-persistent CSI report is deactivated, the information on re-triggering/indicating/activating the sub-configuration is released/stopped/deactivated.

In some embodiments, a size/the number of bits of the first indication field in the downlink control information (DCI) is predefined, or configured by RRC signaling; the number of bits of the first indication field is log 2X; X is the number of trigger (indication/activation) states; wherein, bit numeric values correspond to the trigger (indication/activation) states in a trigger state positional sequence; and
codepoints of the first indication field in the downlink control information are mapped to the trigger (indication/activation) states in the trigger state positional sequence; wherein codepoint “0” or codepoint “1” are mapped to a trigger/indication/activation state at a first position.

In some embodiments, the first indication field in the downlink control information (DCI) is a bitmap; wherein the number of bits of the first indication field is X; X is the number of trigger (indication/activation) states; wherein bit positions correspond to the trigger (indication/activation) states sequentially; and
bits from MSB to LSB in the bitmap correspond to the first to the last trigger/indication/activation states 1 respectively; wherein indicates triggering/indication/activation of a sub-configuration, and 0 indicates releasing/stopping/deactivation of a sub-configuration.

In some embodiments, the indication information is downlink control information (DCI), the downlink control information (DCI) is group common signaling, the downlink control information being scrambled by a second RNTI;
the group common signaling includes a plurality of blocks, each block corresponding to a terminal equipment, and the group common signaling is used to trigger/indicate/activate a sub-configuration of at least one terminal equipment.

In some embodiments, the block is used to indicate the CSI report configuration index and/or at least one sub-configuration of the terminal equipment, the sub-configuration is indicated using codepoints or a bitmap in the block, bit numeric values/positions correspond to the trigger (indication/activation) states sequentially; a bit width of the block is related to the number of sub-configurations and/or a bit width of the CSI report configuration index of the terminal equipment.

In some embodiments, the second RNTI is determined according to a first parameter, and a payload size of the downlink control information is determined according to a fourth parameter; a starting position of corresponding block information of the terminal equipment in the downlink control information (DCI) is determined according to a second parameter; a bit width of a corresponding block of the terminal equipment in the downlink control information (DCI) is determined according to a third parameter; and a bit width of the CSI report configuration index of the terminal equipment is determined according to a fifth parameter.

In some embodiments, the channel state information (CSI) report configuration is for a physical uplink control channel (PUCCH) semi-persistent CSI reporting;
wherein the indication information is a media access control (MAC) control element (CE), the MAC CE activates or deactivates at least one sub-configuration in the plurality of sub-configurations.

In some embodiments, a third trigger/indication/activation list is configured via RRC, a row in the third trigger/indication/activation list corresponds to one CSI report configuration index and/or at least one CSI-RS resource index or at least one sub-configuration.

It's worth noting that the above only describes components or modules related to the present disclosure, but the present disclosure is not limited to this. The apparatus 600 for indicating channel state information may further include other components or modules. For detailed contents of these components or modules, relevant technologies may be referred to.

Moreover, for the sake of simplicity, FIG. 6 only exemplarily shows a connection relationship or signal direction between components or modules, however persons skilled in the art should know that various relevant technologies such as bus connection may be used. The above components or modules may be realized by a hardware facility such as a processor, a memory, a transmitter, a receiver, etc. The embodiments of the present disclosure have no limitation to this.

Through the embodiments of the present disclosure, even in some scenarios (such as an energy-saving mode) of wireless communication applications, a network device is still able to indicate CSI to a terminal equipment efficiently and accurately, thereby the terminal equipment is able to transmit a CSI report efficiently and accurately, CSI reporting overhead can be saved and uplink resources can be saved.

### Embodiments of a Fourth Aspect

Embodiments of the present disclosure provide an apparatus for indicating channel state information. The apparatus may be a network device, or may be one or more parts or components configured in the network device. The contents same as the embodiments of the first and second aspect are not repeated.

FIG. 7 is a schematic diagram of an apparatus for indicating channel state information in the embodiments of the present disclosure. As shown in FIG. 7, the apparatus 700 for indicating channel state information includes:
a first transmitting unit 701, configured to transmit a channel state information (CSI) report configuration, the channel state information (CSI) report configuration being related to L pieces of CSI, the channel state information (CSI) report configuration including S sub-configurations, where 1≤S≤L, one of the S sub-configurations corresponds to at least one piece of channel state information (CSI); and
a second transmitting unit 702, configured to transmit indication information, the indication information being used to trigger (indicate/activate) at least one of the S sub-configurations.

It's worth noting that the above only describes components or modules related to the present disclosure, but the present disclosure is not limited to this. The apparatus 700 for indicating channel state information may further include other components or modules. For detailed contents of these components or modules, relevant technologies may be referred to.

Moreover, for the sake of simplicity, FIG. 7 only exemplarily shows a connection relationship or signal direction between components or modules, however persons skilled in the art should know that various relevant technologies such as bus connection may be used. The above components or modules may be realized by a hardware facility such as a processor, a memory, a transmitter, a receiver, etc. The embodiments of the present disclosure have no limitation to this.

Through the embodiments of the present disclosure, even in some scenarios (such as an energy-saving mode) of wireless communication applications, a network device is still able to indicate CSI to a terminal equipment efficiently and accurately, thereby the terminal equipment is able to transmit a CSI report efficiently and accurately, CSI reporting overhead can be saved and uplink resources can be saved.

### Embodiments of a Fifth Aspect

Embodiments of the present disclosure further provide a communication system, FIG. 1 may be referred to, the contents same as the embodiments of the first to fourth aspects are not repeated.

In some embodiments, a communication system 100 at least may include:
a network device, configured to transmit a channel state information (CSI) report configuration and indication information; and
a terminal equipment, configured to receive the channel state information (CSI) report configuration and the indication information;
wherein the channel state information (CSI) report configuration are related to L pieces of CSI, the channel state information (CSI) report configuration including S sub-configurations, where 1≤S≤L, one of the S sub-configurations corresponds to at least one piece of channel state information (CSI); the indication information is used to trigger (indicate/activate) at least one of the S sub-configurations.

Embodiments of the present disclosure further provide a network device, for example may be a base station, but the present disclosure is not limited to this, it may also be other network device.

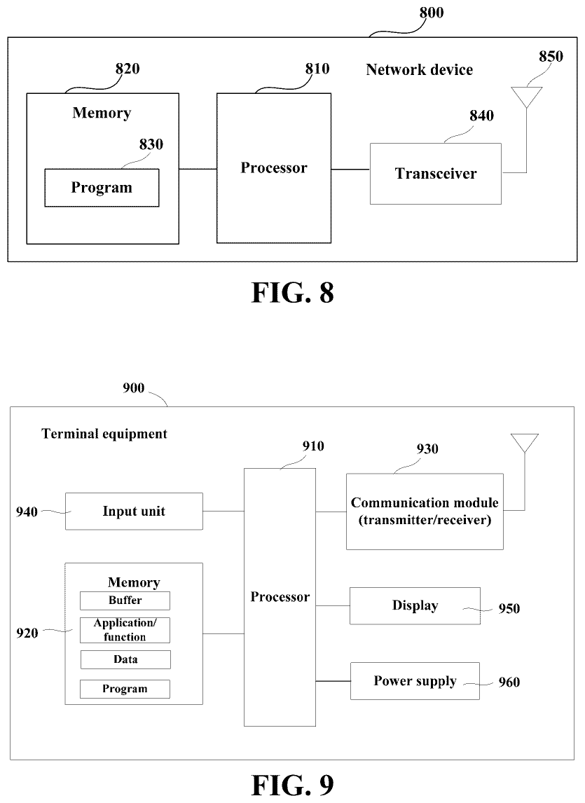

FIG. 8 is a composition schematic diagram of a network device in the embodiments of the present disclosure. As shown in FIG. 8, the network device 800 may include: a processor 810 (such as a central processing unit (CPU)) and a memory 820; the memory 820 is coupled to the processor 810. The memory 820 may store various data; moreover, also stores a program 830 for information processing, and executes the program 830 under the control of the processor 810.

For example, the processor 810 may be configured to execute a program to implement the method for indicating channel state information as described in the embodiments of the second aspect. For example, the processor 810 may be configured to perform the following control: transmitting a channel state information (CSI) report configuration, the channel state information (CSI) report configuration being related to L pieces of CSI, the channel state information (CSI) report configuration including S sub-configurations, where 1≤S≤L, one of the S sub-configurations corresponds to at least one piece of channel state information (CSI); and transmitting indication information, the indication information being used to trigger (indicate/activate) at least one of the S sub-configurations.

In addition, as shown in FIG. 8, the network device 800 may further include: a transceiver 840 and an antenna 850, etc.; wherein the functions of said components are similar to relevant arts, which are not repeated here. It's worth noting that the network device 800 does not have to include all the components shown in FIG. 8. Moreover, the network device 800 may further include components not shown in FIG. 8, relevant arts may be referred to.

Embodiments of the present disclosure further provide a terminal equipment, but the present disclosure is not limited to this, it may also be other device.

FIG. 9 is a schematic diagram of a terminal equipment in the embodiments of the present disclosure. As shown in FIG. 9, the terminal equipment 900 may include a processor 910 and a memory 920; the memory 920 stores data and programs, and is coupled to the processor 910. It's worth noting that this figure is exemplary; other types of structures can also be used to supplement or replace this structure, so as to realize a telecommunication function or other functions.

For example, the processor 910 may be configured to execute a program to implement the method for indicating channel state information as described in the embodiments of the first aspect. For example, the processor 910 may be configured to perform the following control: receiving a channel state information (CSI) report configuration, the channel state information (CSI) report configuration being related to L pieces of CSI, the channel state information (CSI) report configuration including S sub-configurations, where 1≤S≤L, one of the S sub-configurations corresponds to at least one piece of channel state information (CSI); and receiving indication information, the indication information being used to trigger (indicate/activate) at least one of the S sub-configurations.

As shown in FIG. 9, the terminal equipment 900 may further include: a communication module 930, an input unit 940, a display 950 and a power supply 960. The functions of said components are similar to relevant arts, which are not repeated here. It's worth noting that the terminal equipment 900 does not have to include all the components shown in FIG. 9, said components are not indispensable. Moreover, the terminal equipment 900 may further include components not shown in FIG. 9, relevant arts may be referred to.

Embodiments of the present disclosure further provide a computer program, wherein when a terminal equipment executes the program, the program enables the terminal equipment to execute the method for indicating channel state information described in the embodiments of the first aspect.

Embodiments of the present disclosure further provide a storage medium in which a computer program is stored, wherein the computer program enables a terminal equipment to execute the method for indicating channel state information described in the embodiments of the first aspect.

Embodiments of the present disclosure further provide a computer program, wherein when a network device executes the program, the program enables the network device to execute the method for indicating channel state information described in the embodiments of the second aspect.

Embodiments of the present disclosure further provide a storage medium in which a computer program is stored, wherein the computer program enables a network device to execute the method for indicating channel state information described in the embodiments of the second aspect.

The apparatus and method in the present disclosure may be realized by hardware, or may be realized by combining hardware with software. The present disclosure relates to such a computer readable program, when the program is executed by a logic component, the computer readable program enables the logic component to realize the device described in the above text or a constituent component, or enables the logic component to realize various methods or steps described in the above text. The present disclosure further relates to a storage medium storing the program, such as a hard disk, a magnetic disk, an optical disk, a DVD, a flash memory and the like.

By combining with the method/device described in the embodiments of the present disclosure, it may be directly reflected as hardware, a software executed by a processor, or a combination of the two. For example, one or more in the functional block diagram or one or more combinations in the functional block diagram as shown in the drawings may correspond to software modules of a computer program flow, and may also correspond to hardware modules. These software modules may respectively correspond to the steps as shown in the drawings. These hardware modules may be realized by solidifying these software modules e.g. using a field-programmable gate array (FPGA).

A software module may be located in a RAM memory, a flash memory, a ROM memory, an EPROM memory, an EEPROM memory, a register, a hard disk, a mobile magnetic disk, a CD-ROM or a storage medium in any other form as known in this field. A storage medium may be coupled to a processor, thereby enabling the processor to read information from the storage medium, and to write the information into the storage medium; or the storage medium may be a constituent part of the processor. The processor and the storage medium may be located in an ASIC. The software module may be stored in a memory of a mobile terminal, and may also be stored in a memory card of the mobile terminal. For example, if a device (such as the mobile terminal) adopts a MEGA-SIM card with a larger capacity or a flash memory apparatus with a large capacity, the software module may be stored in the MEGA-SIM card or the flash memory apparatus with a large capacity.

One or more in the functional block diagram or one or more combinations in the functional block diagram as described in the drawings may be implemented as a general-purpose processor for performing the functions described in the present disclosure, a digital signal processor (DSP), an application-specific integrated circuit (ASIC), a field-programmable gate array (FPGA) or other programmable logic device, discrete gate or transistor logic device, discrete hardware components or any combination thereof. One or more in the functional block diagram or one or more combinations in the functional block diagram as described in the drawings may further be implemented as a combination of computer equipments, such as a combination of a DSP and a microprocessor, a plurality of microprocessors, one or more microprocessors combined and communicating with the DSP or any other such configuration.

The present disclosure is described by combining with the specific implementations, however persons skilled in the art should clearly know that these descriptions are exemplary and do not limit the protection scope of the present disclosure. Persons skilled in the art may make various variations and modifications to the present disclosure according to the principle of the present disclosure, these variations and modifications are also within the scope of the present disclosure.

As for the implementations including the above embodiments, the following supplements are further disclosed:

1. A method for indicating channel state information (CSI), including:
a terminal equipment receives a channel state information (CSI) report configuration, the channel state information (CSI) report configuration being related to L pieces of CSI, the channel state information (CSI) report configuration including S sub-configurations, where 1≤S≤L, one of the S sub-configurations corresponds to at least one piece of channel state information (CSI); and
the terminal equipment receives indication information, the indication information being used to trigger (indicate/activate) at least one of the S sub-configurations.

2. The method according to supplement 1, wherein the number of PUSCH-based semi-persistent CSI report configurations that include at least one sub-configuration is H, and/or, the number of PUSCH-based aperiodic CSI report configurations that include at least one sub-configuration is Q, and/or, the number of PUCCH-based semi-persistent CSI report configurations that include at least one sub-configuration is R, where H, Q and R are positive integers.

3. The method according to supplement 2, wherein the method further includes:
the terminal equipment performs channel measurement according to triggered (indicated/activated) M sub-configurations in S sub-configurations; and
transmits a channel state information (CSI) report, the channel state information (CSI) report including N pieces of channel state information (CSI); wherein the M sub-configurations correspond to N pieces of channel state information, 1≤M≤N.

4. The method according to any one of supplements 1 to 3, wherein the one sub-configuration includes at least one of the following information:
parameter N1;
parameter N2;
parameter Ng;
a codebook subset restriction; and
port information, the port information being used to indicate partial ports of channel state information reference signal (CSI-RS) resources associated with the channel state information (CSI) report configuration.

5. The method according to any one of supplements 1 to 4, wherein the sub-configuration is included in sub-configuration information (sub-config) of the channel state information (CSI) report configuration, or is included in codebook configuration information (codebook config) of the channel state information (CSI) report configuration, or is included in parameter configuration information (N1-N2 config) of the channel state information (CSI) report configuration.

6. The method according to any one of supplements 1 to 5, wherein the channel state information (CSI) report configuration is for physical uplink shared channel (PUSCH) semi-persistent CSI reporting.

7. The method according to supplement 6, wherein a first trigger/indication/activation state list is configured via RRC, and the first trigger/indication/activation state list includes a set of X1 trigger (indication/activation) states.

8. The method according to any one of supplements 1 to 5, wherein the channel state information (CSI) report configuration is for physical uplink shared channel (PUSCH) aperiodic CSI reporting.

9. The method according to supplement 8, wherein a second trigger/indication/activation state list is configured via RRC, and the second trigger/indication/activation state list includes a set of X2 trigger (indication/activation) states.

10. The method according to any one of supplements 6 to 9, wherein one trigger (indication/activation) state is associated with at least one CSI report configuration index and/or at least one CSI-RS resource index and/or at least one sub-configuration.

11. The method according to any one of supplements 1 to 10, wherein the indication information is downlink control information (DCI).

12. The method according to supplement 11, wherein the downlink control information (DCI) is user-specific (UE-specific), and the downlink control information is scrambled by a first RNTI.

13. The method according to supplement 12, wherein the first RNTI is an RNTI related to network energy saving that is different from an SP-CSI-RNTI or a C-RNTI.

14. The method according to supplement 12, wherein the first RNTI is an SP-CSI-RNTI or a C-RNTI.

15. The method according to supplement 12, wherein the downlink control information (DCI) is of DCI format 0_1 or DCI format 0_2; a CSI request field and/or a first indication field (sub-CSI indication field) in the downlink control information (DCI) is/are used to activate at least one CSI report and/or indicate at least one sub-configuration among the plurality of sub-configurations.

16. The method according to supplement 15, wherein for the PUSCH-based semi-persistent CSI reporting, according to a special field in the downlink control information (DCI), a CSI request field and/or a first indication field (sub-CSI indication field) in the downlink control information (DCI) is/are used to activate/deactivate at least one CSI report and/or indicate at least one sub-configuration among the plurality of sub-configurations.

17. The method according to supplement 16, wherein the specific field in the downlink control information (DCI) is one or more existing fields in the DCI, including a semi-persistent CSI activation/deactivation PDCCH validation field.

18. The method according to supplement 16, wherein the special field in the downlink control information (DCI) is a field related to network energy saving that is different from the semi-persistent CSI activation/deactivation PDCCH validation fields.

19. The method according to any one of supplements 1 to 18, wherein the method further includes:
the terminal equipment receives first DCI scrambled by an SP-CSI-RNTI, a CSI request field of the first DCI is associated with a semi-persistent CSI report having the same identification as the CSI report configuration, and the semi-persistent CSI report is activated by previously received second DCI scrambled by the SP-CSI-RNTI, the first DCI is used to re-trigger/indicate/activate the sub-configuration during activation of the semi-persistent CSI report.

20. The method according to supplement 19, wherein information on re-triggering/indicating/activating the sub-configuration overrides triggering/indication/activation of a previous sub-configuration; and
after the semi-persistent CSI report is deactivated, the information on re-triggering/indicating/activating the sub-configuration is released/stopped/deactivated.

21. The method according to any one of supplements 12 to 20, wherein a size/the number of bits of the first indication field (such as sub-CSI indication field) in the downlink control information (DCI) is predefined, or configured via RRC signaling.

22. The method according to supplement 21, wherein the number of bits of the first indication field is log 2X; X is the number of trigger (indication/activation) states;
wherein bit values correspond to the trigger (indication/activation) states in a trigger state positional sequence.

23. The method according to supplement 21, wherein codepoints of the first indication field in the downlink control information are mapped to the trigger (indication/activation) states in the trigger state positional sequence;
wherein codepoint “0” or codepoint “1” are mapped to a trigger/indication/activation state at a first position.

24. The method according to any one of supplements 12 to 20, wherein the first indication field (sub-CSI indication field) in the downlink control information (DCI) is a bitmap.

25. The method according to supplement 24, wherein the number of bits of the first indication field is X; X is the number of trigger (indication/activation) states;
wherein bit positions correspond to the trigger (indication/activation) states sequentially.

26. The method according to supplement 24, wherein bits from the Most Significant Bit (MSB) to the Least Significant Bit (LSB) of the bitmap correspond to the first to the last trigger/indication/activation states respectively;
wherein 1 indicates triggering/indication/activation of a sub-configuration, and 0 indicates releasing/stopping/deactivation of a sub-configuration.

27. The method according to supplement 11, wherein the downlink control information (DCI) is group common signaling, the downlink control information being scrambled by a second RNTI.

28. The method according to supplement 27, wherein the group common signaling includes a plurality of blocks, each block corresponding to a terminal equipment, and the group common signaling is used to trigger/indicate/activate a sub-configuration of at least one terminal equipment.

29. The method according to supplement 28, wherein the block is used to indicate the CSI report configuration index and/or at least one sub-configuration of the terminal equipment, the sub-configuration is indicated using codepoints or a bitmap in the block, bit numeric values/positions correspond to the trigger (indication/activation) states sequentially.

30. The method according to supplement 28, wherein a bit width of the block is related to the number of sub-configurations and/or a bit width of the CSI report configuration index of the terminal equipment.

31. The method according to any one of supplements 28 to 30, wherein the second RNTI is determined according to a first parameter, and a payload size of the downlink control information is determined according to a fourth parameter; a starting position of corresponding block information of the terminal equipment in the downlink control information (DCI) is determined according to a second parameter; a bit width of a corresponding block of the terminal equipment in the downlink control information (DCI) is determined according to a third parameter; and a bit width of the CSI report configuration index of the terminal equipment is determined according to a fifth parameter.

32. The method according to any one of supplements 1 to 5, wherein the channel state information (CSI) report configuration is for a physical uplink control channel (PUCCH) semi-persistent CSI reporting.

33. The method according to supplement 32, wherein the indication information is a media access control (MAC) control element (CE), the MAC CE activates or deactivates at least one sub-configuration in the plurality of sub-configurations.

34. The method according to supplement 32, wherein a third trigger/indication/activation list is configured via RRC, a row in the third trigger/indication/activation list corresponds to one CSI report configuration index and/or at least one CSI-RS resource index or at least one sub-configuration.

35. A method for indicating channel state information (CSI), including:
a network device transmits a channel state information (CSI) report configuration, the channel state information (CSI) report configuration being related to L pieces of CSI, the channel state information (CSI) report configuration including S sub-configurations, where 1≤S≤L, one of the S sub-configurations corresponds to at least one piece of channel state information (CSI); and
the network device transmits indication information, the indication information being used to trigger (indicate/activate) at least one of the S sub-configurations.

36. A terminal equipment, including a memory and a processor, the memory storing a computer program, and the processor being configured to execute the computer program to implement the method for indicating channel state information according to any one of supplements 1 to 34.

37. A network device, including a memory and a processor, the memory storing a computer program, and the processor being configured to execute the method for indicating channel state information according to supplement 35.

What is claimed is:

1. An apparatus for reporting channel state information, the apparatus comprising:
a first receiver, configured to receive a channel state information (CSI) report configuration, the CSI report configuration being related to L CSI sub-reports, the CSI report configuration comprising a first sub-configuration list, the first sub-configuration list comprising L sub-configurations, one of the L sub-configurations corresponds to one of the L CSI sub-reports;
a second receiver, configured to receive indication information, the indication information being used to trigger/indicate/activate M sub-configurations of the L sub-configurations, M equals to or more than 1 and less than or equal to L;
wherein the CSI report configuration is for semi-persistent reporting on PUSCH; and a first trigger state list is configured via a higher layer signaling, the first trigger state list comprising a set of trigger states;
or, the CSI report configuration is for aperiodic reporting on PUSCH; and a second trigger state list is configured via a higher layer signaling, the second trigger state list comprising a set of trigger states.

2. The apparatus according to claim 1, wherein,
the higher signaling to configure the first trigger state list is radio resource control signaling, the first trigger state list comprising X1 trigger states, and/or, the higher layer signaling to configure the second trigger state list is radio resource control signaling, the second trigger state list comprising X2 trigger states;
wherein a trigger state of the first trigger state list or the second trigger state list is associated with at least one sub-configuration out of the first sub-configuration list of the L sub-configurations.

3. The apparatus according to claim 1, wherein the first trigger state list is CSI-SemiPersistentOnPUSCH-TriggerStateList, and/or, the second trigger state list is CSI-AperiodicTriggerStateList.

4. The apparatus according to claim 1, wherein a trigger state in the first trigger state list at least comprises the CSI report configuration being associated with the trigger state.

5. The apparatus according to claim 4, wherein the trigger state in the first trigger state list further comprises a second sub-configurations list;
wherein the second sub-configuration list comprises M2 sub-configuration IDs out of the first sub-configuration list of the L sub-configurations, M2 being equal to or more than 1.

6. The apparatus according to claim 1, wherein a trigger state in the second trigger state list at least comprises the CSI report configuration being associated with the trigger state.

7. The apparatus according to claim 6, wherein the trigger state in the second trigger state list further comprises a third sub-configuration list;
wherein the third sub-configuration list comprises M3 sub-configuration IDs out of the first sub-configuration list of the L sub-configurations, M3 being equal to or more than 1.

8. The apparatus according to claim 1, wherein the apparatus further comprises:
a processor, configured to perform channel measurement according to the M sub-configurations triggered/indicated/activated by the indication information; and
a transmitter, configured to transmit a CSI report, the CSI report at least comprising M CSI sub-reports; wherein one of the M CSI sub-reports corresponds to one of the M sub-configurations.

9. The apparatus according to claim 1, wherein one of the L sub-configurations comprises at least one of the following information: information being related to parameter N1; information being related to parameter N2; information being related to parameter Ng; information being related to a codebook subset restriction; or port information, the port information being used to indicate a port subset of at least one CSI-RS resource associated with the CSI report configuration; and
the sub-configuration is included in the first sub-configuration list of the CSI report configuration.

10. The apparatus according to claim 1, wherein the indication information is downlink control information (DCI); and
the DCI is scrambled by SP-CSI-RNTI or C-RNTI;
wherein the DCI is of DCI format 0_1 or DCI format 0_2; a CSI request field in the DCI is at least used to trigger/indicate/activate M sub-configurations of the L sub-configurations.

11. An apparatus for configuring channel state information reporting, the apparatus comprising:
a first transmitter, configured to transmit a channel state information (CSI) report configuration, the CSI report configuration being related to L CSI sub-reports, the CSI report configuration comprising a first sub-configuration list, the first sub-configuration list comprising L sub-configurations, one of the L sub-configurations corresponds to one of the L CSI sub-reports;
a second transmitter, configured to transmit indication information, the indication information being used to trigger/indicate/activate M sub-configurations of the L sub-configurations, M equals to or more than 1 and less than or equal to L;
wherein the CSI report configuration is for semi-persistent reporting on PUSCH; and a first trigger state list is configured via a higher layer signaling, the first trigger state list comprising a set of trigger states;
or, the CSI report configuration is for aperiodic reporting on PUSCH; and a second trigger state list is configured via a higher layer signaling, the second trigger state list comprising a set of trigger states.

12. The apparatus according to claim 11, wherein,
the higher signaling to configure the first trigger state list is radio resource control signaling, the first trigger state list comprising X1 trigger states, and/or, the higher layer signaling to configure the second trigger state list is radio resource control signaling, the second trigger state list comprising X2 trigger states;
wherein a trigger state of the first trigger state list or the second trigger state list is associated with at least one sub-configuration out of the first sub-configuration list of the L sub-configurations.

13. The apparatus according to claim 11, wherein the first trigger state list is CSI-SemiPersistentOnPUSCH-TriggerStateList, and/or, the second trigger state list is CSI-AperiodicTriggerStateList.

14. The apparatus according to claim 11, wherein a trigger state in the first trigger state list at least comprises the CSI report configuration being associated with the trigger state.

15. The apparatus according to claim 14, wherein the trigger state in the first trigger state list further comprises a second sub-configurations list;
wherein the second sub-configuration list comprises M2 sub-configuration IDs out of the first sub-configuration list of the L sub-configurations, M2 being equal to or more than 1.

16. The apparatus according to claim 11, wherein a trigger state in the second trigger state list at least comprises the CSI report configuration being associated with the trigger state.

17. The apparatus according to claim 16, wherein the trigger state further comprises a third sub-configuration list;
wherein the third sub-configuration list comprises M3 sub-configuration IDs out of the first sub-configuration list of the L sub-configurations, M3 being equal to or more than 1.

18. The apparatus according to claim 11, wherein the apparatus further comprises:
a receiver, configured to receive a CSI report, the CSI report at least comprising M sub-reports; wherein one of the M CSI sub-reports corresponds to one of M sub-configurations triggered/indicated/activated by the indication information.

19. The apparatus according to claim 11, wherein one of the L sub-configurations comprises at least one of the following information: information being related to parameter N1; information being related to parameter N2; information being related to parameter Ng; information being related to a codebook subset restriction; or port information, the port information being used to indicate a port subset of at least one CSI-RS resource associated with the CSI report configuration; and
the sub-configuration is included in the first sub-configuration list of the CSI report configuration.

20. A communication system, comprising:
a network device, configured to transmit a channel state information (CSI) report configuration and indication information; and
a terminal equipment, configured to receive the CSI report configuration and the indication information;
wherein the CSI report configuration is related to L CSI sub-reports, the CSI report configuration comprising a first sub-configuration list, the first sub-configuration list comprising L sub-configurations, one of the L sub-configurations corresponds to one of the L CSI sub-reports; the indication information is used to trigger/indicate/activate M sub-configurations of the L sub-configurations, M equals to or more than 1 and less than or equal to L;
wherein the CSI report configuration is for semi-persistent reporting on PUSCH; and a first trigger state list is configured via a higher layer signaling, the first trigger state list comprising a set of trigger states;
or, the CSI report configuration is for aperiodic reporting on PUSCH; and a second trigger state list is configured via a higher layer signaling, the second trigger state list comprising a set of trigger states.
